(19) United States
(12) Patent Application Publication
(10) Pub. No.: US 2004/0204998 A1
(43) Pub. Date: Oct. 14, 2004

(54) System and method for placing orders

(76) Inventors: Rachana Shah, Sunnyvale, CA (US); Marie-Anne Truong, Milpitas, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/410,411

(22) Filed: Apr. 8, 2003

(51) Int. Cl. G06F 17/60

(52) U.S. Cl. 705/16

(57) ABSTRACT

Embodiments of the invention provide a system and method for producing, in an electronic commerce environment, an identification for a customer. The method includes entering in an electronic commerce environment customer identification information comprising a combination of a first customer identifying characteristic and a second customer identifying characteristic, and determining that the customer identification information exist in data storage. The customer may include a group of individuals with each individual having the same username and a different password.

### CROSS-REFERENCES TO RELATED APPLICATIONS

This patent application is related to the following commonly-assigned patent applications: U.S. patent application Ser. No. 10/XXX,XXX (Attorney Docket No. 200209676-1), entitled “System And Method For Issuing Coupons”; U.S. patent application Ser. No. 10/XXX,XXX (Attorney Docket No. 200209674-1) entitled “System And Method For Redeeming Coupons”; and U.S. patent application Ser. No. 10/XXX,XXX (Attorney Docket No. 200205302-1), entitled “System And Method For Creating A Campaign”. All of the above U.S. Patent Applications are hereby fully incorporated herein by reference.

### TECHNICAL FIELD

Embodiments of the invention relate generally to an electronic commerce environment. More particularly, embodiments of the invention relate to a system and method for placing an order in an electronic commerce environment.

### BACKGROUND ART

In an electronic commerce environment, there is a desire to increase customer satisfaction by having the capability of multi-user E-mail addresses. However, it would also be beneficial for customers to have multiple accounts with the same user name (i.e., E-mail address) but with different passwords for security purposes. Current technology does not permit a system and method that provides for a multi-user E-mail address so that more than one person (e.g., a family, a group of relatives, a partnership or other legal entity, and/or the like) may share the same E-mail address, yet have different individual accounts for electronic shopping purposes. Thus, in these systems and methods, if one user forgets his/her password, such person may easily create another separate account while still continuing to use the same E-mail address, but with a new password. Each user ID would be unique so people can not log into another's account. Current systems and methods do not enable electronic commerce shopping under a unique user name by groups of customers having a close relationship, while yet still maintaining separate accounts.

### SUMMARY OF EMBODIMENTS OF THE INVENTION

Embodiments of the invention provide a method for placing an order in an electronic commerce environment comprising entering in an electronic commerce environment customer-identification information including a combination of a first customer identifying characteristic and a second customer identifying characteristic. The method for placing an order also comprises determining that the customer-identification information exists in data storage (such as a table or the like), and placing an order for a product in the electronic commerce environment. The method for placing may also further comprise determining that the first customer identifying characteristic is in a desired format. The customer may comprise a group with each member of the group having the same first customer identifying characteristic and a different second customer identifying characteristic. The first customer identifying characteristic comprises a username (e.g., an email address), and the second customer identifying characteristic comprises a password (e.g., an account number). Thus, and more specifically, the customer may include a group with each member of the group having the same username and a different password.

Additional embodiments of the invention include a method for a customer to enter an electronic commerce environment and to purchase a product comprising entering in an electronic commerce environment customer-identification information including a combination of a first customer identifying characteristic and a second customer identifying characteristic, determining that first customer identifying characteristic is in a desired format (e.g., an email format), determining that the customer-identification information exists in data storage for allowing a customer to enter an electronic commerce environment, and purchasing a product. The method for a customer to enter an electronic commerce environment and to purchase a product may additionally comprise updating a user field of a sign-in page with the customer-identification information.

In another embodiment, an apparatus for placing an order in an electronic commerce environment, includes: a computer system configured to enter in an electronic commerce environment customer identification information comprising a combination of a first customer identifying characteristic and a second customer identifying characteristic, to determine that the customer identification information exist in data storage, and to place an order for a product in the electronic commerce environment. These and other features of an embodiment of the invention will be readily apparent to persons of ordinary skill in the art upon reading the entirety of this disclosure, which includes the accompanying drawings and claims.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 is a schematic block diagram that exemplarily illustrates a computer system which may be employed for various embodiments of the invention.

FIG. 2 is a functional diagram illustrating a computer network where embodiments of the invention may be employed.

FIG. 3 illustrates a schematic diagram of a system for creating and publishing web pages which may be employed for various embodiments of the invention.

FIG. 4 is a schematic flow diagram of logic employed by a computer system for a customer to sign-in by entering his/her username and password.

FIG. 5 is a schematic flow diagram of logic employed by a computer system for a customer to check out after purchasing one or more products.

FIG. 6 is a schematic flow diagram of logic employed by a computer system for a customer to submit an order for purchasing one or more products.

FIG. 7 is a schematic flow diagram of logic employed by a computer system for a customer to register.

FIG. 8 is a schematic flow diagram of logic employed by a computer system for conducting an EPP/APP registration process.

FIG. 9 is a schematic flow diagram of logic employed by a computer system for regular-user customers to sign-in.

FIG. 10 is a schematic flow diagram of logic employed by a computer system for EPP users to sign-in.

FIG. 11 is a schematic flow diagram of logic employed by a computer system for regular-user customers and EPP users to sign-in.

FIG. 12 is a schematic flow diagram of logic employed by a computer system for customers to change a password.

FIG. 13 is a schematic flow diagram of logic employed by a computer system for customers to change an E-mail page.

FIG. 14 is a schematic flow diagram of logic employed by a computer system in the event a customer forgets a password.

FIG. 15 is a schematic flow diagram of logic employed by a computer system for a user (e.g., a vendor) to update a profile.

FIG. 16 is a schematic flow diagram of logic employed by a computer system for an agent of a user (e.g., a vendor) to create an account for a customer.

FIG. 17 is a schematic flow diagram of logic employed by a computer system for an agent of a user (e.g., a vendor) to update and edit a profile page of a customer.

### DETAILED DESCRIPTION OF EMBODIMENTS OF THE INVENTION

In the description herein, numerous specific details are provided, such as examples of components and/or methods, to provide a thorough understanding of embodiments of the invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the invention.

A “computer” for purposes of embodiments of the invention may be any processor-containing device, such as a mainframe computer, a personal computer, a laptop, a notebook, a microcomputer, a server, or any of the like. A “computer program” may be any suitable program or sequence of coded instructions which are to be inserted into a computer, well known to those skilled in the art. Stated more specifically, a computer program is an organized list of instructions that, when executed, causes the computer to behave in a predetermined manner. A computer program contains a list of ingredients (called variables) and a list of directions (called statements) that tell the computer what to do with the variables. The variables may represent numeric data, text, or graphical images.

A “computer-readable medium” for purposes of embodiments of the invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

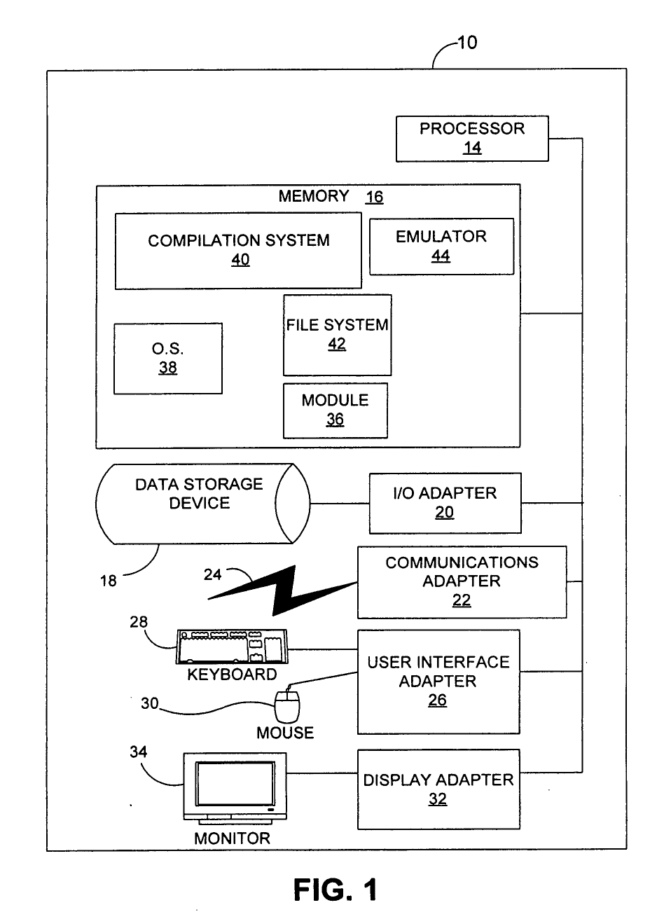

Referring now to FIG. 1 there is broadly illustrated a computer system 10 which may be employed for various embodiments of the invention. The computer system 10 includes a computer program and various components, such as a processor 14, a computer memory 16, a data storage device 18, an input/output (I/O) adapter 20, a communications adapter 22, a communications network 24, a user interface adapter 26, a keyboard 28, a mouse 30, a display adapter 32, and a computer monitor 34. It is to be understood and appreciated by those skilled in the relevant art that there are many possible configurations and arrangements of the components of the computer system 10 and that some components which may be typically included in the computer system 10 are not shown. Thus, the computer system 10 illustrated in FIG. 1 is for exemplarily purposes only and is not to unduly limit the spirit and scope of embodiments of the invention.

Computer memory 16 may be any suitable memory storage device, including random access memory (RAM), cache memory, magnetic medium such as a resident hard disk, or other memory storage devices. The term “storage” may refer to computer resources, such as the computer memory 16, and may be employed to store suitable data or instructions. For exemplarily purposes only and as best illustrated in FIG. 1, computer memory 16 may include at least one module 36, an operating system (O.S.) 38, a compilation system 40, a file system 42, and an emulator 44.

The compilation system 40 for various embodiments of the invention would comprise a compiler having a special program that processes statements written in a particular programming language and turns them into machine language or “code” that a processor, such as processor 14, uses. Traditionally, the output of a compilation system, such as compilation system 40, has been called object code or sometimes an object module. It is well known that the object code is machine code that the processor of the computer can process or “execute” one instruction at a time. Thus, stated alternatively, the compiler translates source code into object code, particularly by looking at the entire piece of source code and collecting and reorganizing the instructions.

Continuing to refer to FIG. 1 the processor 14 typically operates in cooperation with suitable software programs, including the computer memory 16, more particularly including the compilation system 40, the O.S. 38 and the module 36. Henceforth, the fact of such cooperation among the processor 14 and these components of the computer memory 16, whether implemented in software, hardware, firmware, or any combination thereof, may therefore not be repeated or further described, but will be implied for purposes of various embodiments of the invention. It is well known that a module, such as the module 36, typically operates in cooperation with the emulator 44 and the compilation system 40, but is not limited to such operation. By way of example only, the module 36 may operate in cooperation with the O.S. 38, which may in itself cooperate with the compilation system 40. The O.S. 38 may also cooperate with the file system 42 that manages the storage and access to files within the computer system 10.

The module 36 may be implemented in any suitable program language, or in any combination of software, hardware, or firmware. Thus, the module 36 may include instructions and data and be embodied in a computer-readable medium for use by or in connection with an instruction execution system, apparatus, or device, such as the computer system 10 which may pursue and derive any suitable instructions for operation. Any function ascribed to the module 36 and any of its associated functional files, whether implemented in software, hardware, firmware, or any combination thereof, may be included in the functions of the O.S. 38, since the O.S. 38 may include files from the module 36. In some instances, the functions ascribed to the module 36 may be typically performed by the processor 14 executing suitable software instructions in cooperation with aspects of the O.S. 38 that may incorporate the module 36. Therefore, it is to be understood that the module 36 may cooperate with aspects of the O.S. 38.

It will be appreciated by those skilled in the relevant art that the term “execute” may mean the process of manipulating code, such as software, for operation on the computer system 10. It will be further appreciated by those skilled in the relevant art that the term “code” may refer to any suitable instructions or data used by the computer system 10 for the purpose of generating instructions that can execute in the computer system 10. As indicated, the term “module” may refer to a software “procedure” or “function” such as a unit of code that may be independently compiled.

The emulator 44, as well as the compilation system 40 and the O.S. 38, may reside in the computer system 10, more particularly in the computer memory 16 of the computer system 10. The emulator 44 may substitute instructions typically associated with a different computer system than the executing computer system 10, for any original instruction. Any substitute instruction may be associated with a hardware, software, or firmware representation of a different computer system 10.

The data storage device 18 may be any suitable storage device, including a compact disk drive, a tape drive, a removable hard disk drive, or diskette drive. The data storage device 18 may communicate with the I/O adapter 20, which in turn communicates with other components of the computer system 10, in order to retrieve and store data used by the computer system 10. The data storage device 18 typically includes a computer storage medium having stored therein a computer software program and data.

The computer system 10 for embodiments of the invention includes suitable input/output devices for accepting input information and promulgating generated information. Input/output devices may include any suitable storage device, such as a compact disk drive, a tape drive, a removable hard disk drive, or a diskette drive. Suitable input devices include, by way of example only, the keyboard 28, the mouse 30, a touch-screen display (not shown), a touch pad (not shown), a microphone including a voice recognition device (not shown), a network card (not shown), or a modem (not shown). The input devices may communicate with the user interface adapter 26 which in turn communicates with components in the computer system 10 for processing input and output commands. Program code may typically be loaded through a suitable input device and may be stored on the data storage device 18. A copy of the program code, or any portion thereof, may alternatively be disposed by the processor 14 in the computer memory 16 for subsequent execution on the computer system 10.

Output devices may include any suitable output devices for presenting generated information to a user, whether a human or a machine, and whether local or remote. Such devices may include, by way of example only, the computer monitor 34, a printer (not shown), an audio speaker with a voice synthesis device (not shown), a network card (not shown), or a modem (not shown). Output devices, such as the monitor 34, may communicate with other components in the computer system 10 through the display adapter 32.

The computer system 10 for various embodiments of the invention may communicate with communications network 24 via the communications adapter 22, such as a networking card. It is to be appreciated that any suitable input/output device employed by the module 36 may be coupled to the communications network 24 through the communications adapter 22 and therefore may not necessarily be co-located with the computer system 10. Similarly other portions of the computer system 10, such as the data storage device 18 and the monitor 34, may be coupled to the communications network 24 through the communications adapter 22 and may also not be necessarily co-located with the computer system 10.

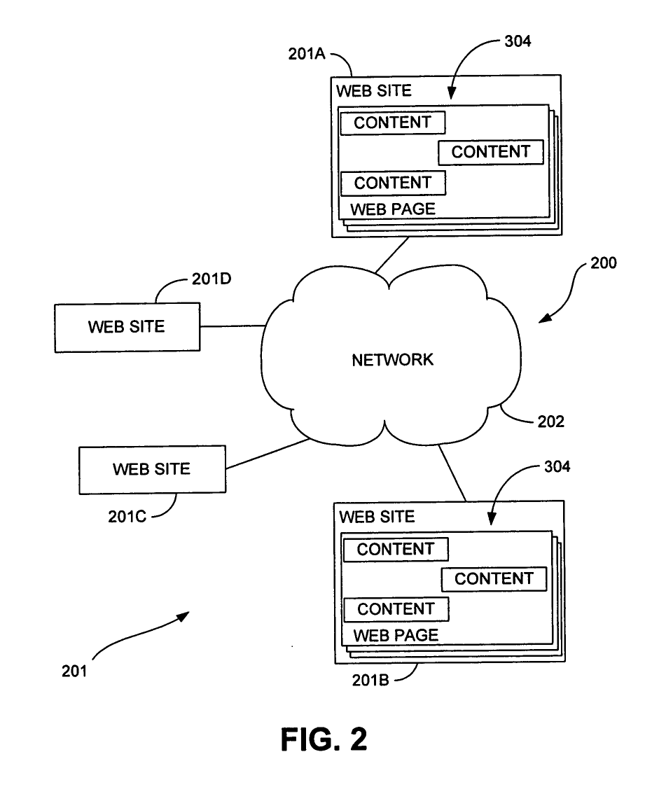

It is to be appreciated that the communications network 24 may be a local area network, a wide area network, or any other suitable computer network, such as network 202 in FIG. 2. Network 202 may be an intranet or the Internet which enables fast and relatively widespread dissemination of information. On the Internet, for example, web sites containing one or more web pages may be accessed by users having a computer system (e.g., computer system 10), a web browser, and a device (e.g., communications adapter 22) for coupling the computer system to the Internet. A web page may contain information on various topics, such as topics (e.g., creating campaigns, redeeming coupons, distribution of coupons, etc) pertaining to electronic-commerce embodiments of the invention.

Embodiments of the invention will be described in the context of web page publishing on the Internet. It should be understood, however, that embodiments of the invention are not to be limited to web page publishing on the Internet and may be used in any suitable electronic-commerce environment, including intranet, telefaxing, telephone, and so forth.

Referring again now to FIG. 2, there is seen a web site assembly, generally illustrated as 200, where embodiments of the invention may be employed. In FIG. 2 one or more web sites 201 (e.g., web sites 201A, 201B, 201C and 201D) which couple to and communicate with the network 202. As indicated the network 202 may include the Internet, an intranet or any other type of computer networks.

The web site 201 may be hosted in a computer system, such as computer system 10, or any data processing device which is capable of communication over a network, such as network 202. By way of example only, the web site may be hosted in a web server computer such as those available from the Hewlett-Packard Company. As illustrated in FIG. 2, the web site 201 may include one or more web pages, with each page including various contents, such as images, text, computer programs, downloadable files, audio, video, etc. The web pages may be structured such that they are on various levels. For example, a home page may be presented as a first level web page, with a hyperlink on the home page allowing access to a second level web page, and so on.

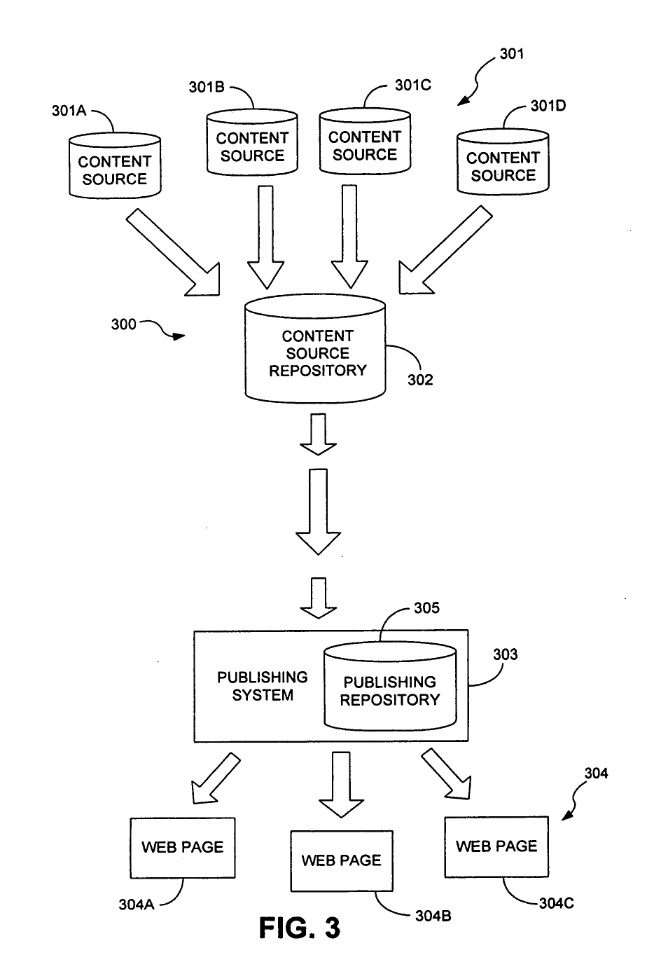

Referring now to FIG. 3, there is illustrated a schematic diagram for a system, generally illustrated as 300, that be used for creating and publishing web pages which may be employed for various embodiments of the invention. The components of system 300, as well as all other components referred to herein, may be implemented in hardware, software, or a combination of hardware and software, such as firmware. As seen in FIG. 3, a content-source repository 302 receives contents from content sources (e.g., content sources 301A, 310B, 301C and 301D). A content source 301 may a local or remote file system, a remote repository, or web site personnel entering content from a suitable terminal, etc. By way of example only, the content source 301 may be a database in a remote data center in communication with a suitable computer system, such as computer system 10, having the content-source repository 302 (e.g., the data storage device 18 functioning as a repository). The content sources may come from various sources, such advertising and sales from a marketing department. For various embodiments of the invention content sources may include a field for receiving a campaign name, a field for receiving a distribution type, a field for receiving a product ID, etc.

The content source repository 302 includes a database that serves as a central repository of contents from the various sources. The database may be any suitable data base such as the type available from the Oracle Corporation. Contents may be stored and retrieved from content source repository 302 as data or objects. Contents uploaded to content source repository 302 from a file system may be stored as binary data or referenced with pointers to the file system.

As appreciated by those artisans skilled in the art, content source repository 302 facilitates collection and retrieval of contents. Contents that may be shared among web pages may be stored in the content source repository 302. By storing appropriate contents in the content source instead of simply entering them directly into a web page, contents from different sources may be created once and used multiple times in different web pages. Content source repository 302 also facilitates control of content type and format so that the resulting web pages conform to a common standard, maintain a consistent look and feel, and uniformly display brands or trademarks and the like.

Appropriate content may be removed or pulled from content source repository 302 as needed by a computer-hosting publishing system 303 which publishes a web page 304 (e.g., web pages 304A, 304B, 304C) in a suitable computer network, such as an intranet or Internet. Publishing system 303 includes a publishing repository 305 (e.g., a database) for storing contents of web pages to be published. As indicated, such contents may be copied from content source repository 302 into a publishing repository 305. This allows web pages 304 to receive content from publishing repository 305.

Storing the content of web pages 304 in publishing repository 305 removes a storage burden from the content source repository 302 and facilitates publication of web pages 304. Additionally, it allows available contents in the provisioning repository 302 to be separated from contents (i.e., those in publication repository 305) which are to be published for better control of the publication process by the publishing system 303 and web pages 304.

A web page 304 may be published by storing it in a web server computer. A web page 304 may also be published by dynamically creating and delivering it to a node in a computer network upon request. Once a web page 304 is published, computers coupled to the same network as the web server computer may then access the web page 304. For example, the web page 304 may be published by making it available from a web site accessible via the intranet or the Internet.

Each web page (e.g., web page 304) or screen shot for various embodiments of the invention is presented or created to that a developer can develop the page (e.g., by using broad vision). Each web page will define and/or present the following information: (i)business requirements: an overview of the web page, including description and functionality; (ii)logic description: a logical breakdown of the web page and the processes that will happen; (iii)associated script: a list of JavaScript page names for pages specific to the particular component being referenced; (iv)information captured: this is information that was captured and will be accessed by the current web page for processing and display, and emanates from one of previous page, session, database, and user input; (v)information provided: this is information generated on the current web page and passed on for use later, and has a destination from one of next page, session, and database; and (vi)navigation choices: are any additional navigation links (textural or graphical) that will be listed (excluding framework navigation) including links to external applications, with each navigation link provided with the following information: (a)the name of the navigation link, (b)the link to web page reference, (c)whether the navigation link is textual or graphical, and (d)communities of visitors who have access to view the provided information, with a user in some instances having access to view a navigation link but having to register before accessing the provided information by the navigation link.

Each web page will contain the following standard framework and are provided to all users regardless of type or role: (i)navigation bar: this is a left hand contextual navigation bar having content sections that will change depending on the page the user is on; (ii)top banner: this contains general navigation bars and a banner at the top of the page, with the available links changing depending on the type of user and whether a user is logged in(note: when a navigation bar element is used to link to a web page, the banner title is typically the same as the navigation bar title; (iii)bottom banner: contains legal information including links to terms of use and privacy statement; and (iv)content area: this is a main display area for content.

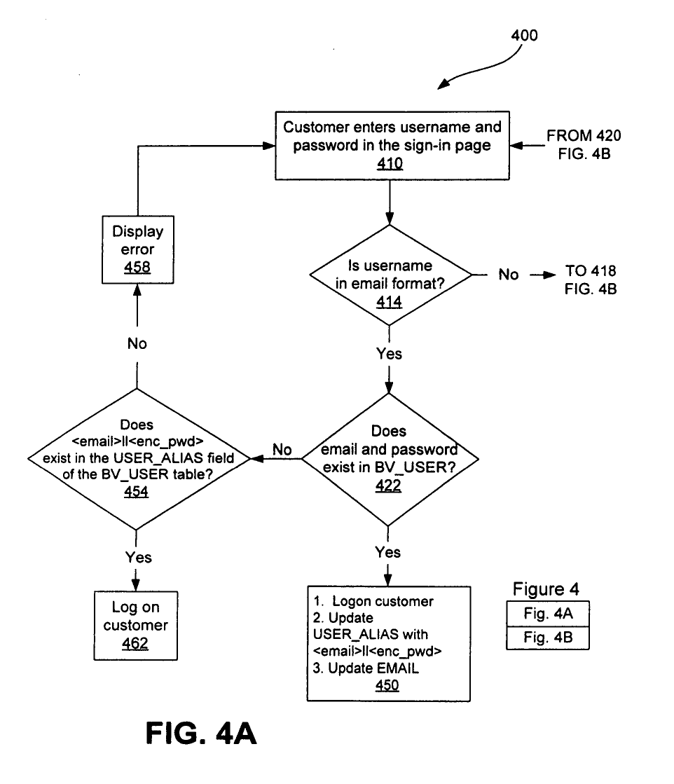

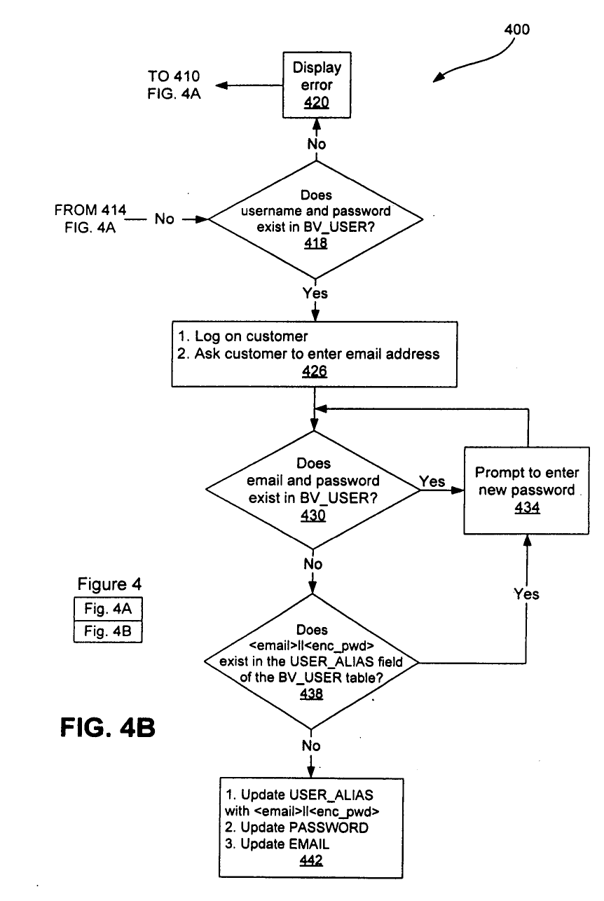

Referring now to FIG. 4 there is seen a logic flow diagram 400 employed by a computer (e.g., computer system 10 including appropriate code) for a user to login. The following logic will be performed by the logic flow diagram 400 of FIG. 4: (i)if customer enters incorrect information or does not enter information in all required fields, an error message will be displayed; (ii)if customer enters a valid username and password, the customer will be logged on; (iii)if customer enters a username different than email address, customer will be prompted to enter an email address so that email address and password will be used for future sign-in; (iv)if customer enters email-password combination that already exists in a BV_USER table (i.e., a data storage of emails/passwords, such as for customers), customer will be asked to enter a new password; (v)if customer enters a unique email-password combination, a field (e.g., a USER_ALIAS field) of the BV USER table will be updated with <email>||<encrypted password> and an email field (e.g., an EMAIL field) of a profile data storage system (e.g., a BV_USER_PROFILE table) will be updated with the email; and (vi)the bivisitor cookie will be the integer “3” for any customer who signs in during checkout.

More specifically with respect to the logic flow diagram 400, in block 410 the customer enters username and password in a sign-in page which may be set forth or otherwise presented on one or more of the web pages 304 of the publishing system 303. When the sign-in page is suitably displayed, and after the username and password have been entered, the logic flow diagram 400 proceeds to decision block 414 to determine if the username is in email format. If username is not in email format, then the logic flow diagram 400 proceeds to decision block 418. If the username is in email format, then the logic flow diagram 400 proceeds to decision block 422.

In decision block 418 a determination is made if the username and password exist in BV_USER. If the determination is negative or no, then an error is displayed in accordance with block 420 (i.e., “display error” block 420) and the logic flow returns to block 410. If the determination is affirmative or yes, then the logic flow proceeds to block 426 for logging on the customer and asking the customer to enter his/her email address. From block 426 the logic flow proceeds to decision block 430 for determining if the email and password exist in BV_USER. If they do exist, the customer will be prompted to enter new password in accordance with block 434 and the logic flow returns to decision block 430. If they do not exist, then the logic flow proceeds to decision block 438 for determining if <email>||<encrypted password> exist in the USER_ALIAS field of the BV_USER table. If they do exist in such location, then the customer is prompted to enter new password in accordance with block 434. If they do not exist in such location, then the following are updated in accordance with block 442: USER_ALIAS with <email>||<encrypted password>, the password, and email.

In decision block 422 a determination is made if email and password exist in BV_USER. If they do exist is such location, then the following are updated in accordance with block 450: USER_ALIAS with <email>||<encrypted password>, the password, and email. If they do not exist in such location, then the logic proceeds to decision block 454 to determine if <email>||<encrypted password> exist in the USER_ALIAS field of the BV_USER table. If they do, then the customer is logged on in accordance with block 462. if they do not exist is such field, then an error is displayed in accordance with block 458 and the logic flow diagram 400 proceeds back to block 410.

Thus, by practice of embodiments of the invention associated with the logic flow diagram of FIG. 4, a login page is created in which customer can enter his/her username and password. If a customer signs-in with username different than email address, the customer will be asked to use his/her email address and password for future sign-in. A customer has the option to edit his/her email address, and there is a link to the “forgot your password” page.

The associated scripts for embodiments of the invention illustrated in the logic flow diagram of FIG. 4 include profile/signin_views.jsp, profile/signin_control.jsp, profile/convert_username_view.jsp, and profile/convert_usernamne_control.jsp.

The information captured in embodiments of the invention illustrated in FIG. 4 is listed in the following Table I:

TABLE I

| | | Information | | |
|---|---|---|---|---|
| Element | Format | Source | Stored In | Comments |
| User | Database | BV_USER | USER_ALIAS | Will pull user |
| alias | | | | alias from BV_USER |
| | | | | if user was already |
| | | | | signed in |
| Password | User | Form password | Html form | Used to sign in |
| | input | input | | customer |
| Email | Database | BV_USER_PROFILE | Email | Will pull email |
| | | | | from |
| | | | | BV_USER_PROFILE if |
| | | | | user was already |
| | | | | sign in |
| User type | Database | Previous page | Request | Used to determine |
| | | | value | whether or not user |
| | | | | alias and email |
| | | | | will be prefilled |

The information provided in embodiments of the invention illustrated in FIG. 4 is listed in the following Table II:

TABLE II

| | | Information | | |
|---|---|---|---|---|
| Element | Format | Source | Stored In | Comments |
| Information | Href | Current page | Scripts | Used to link to |
| page URL | link | | | billing/shipping |
| Convert | Href | Current page | Scripts | Used to link to |
| username | link | | | the conversion |
| page URL | | | | of username to |
| | | | | email address |
| | | | | page |
| BI cookie | Session | Current page | Session | Used for Business |
| variable | | | variable | Intelligence |
| | | | | reporting |

The navigation choices for embodiments of the invention illustrated in FIG. 4 is listed in the following Table III:

TABLE III

| Link Name | Format | Link To | Comments |
|---|---|---|---|
| Secure link | Href link | Forgot password | Secure description |
| | | page | |
| Submit link | Form image input | Same page | For processing |

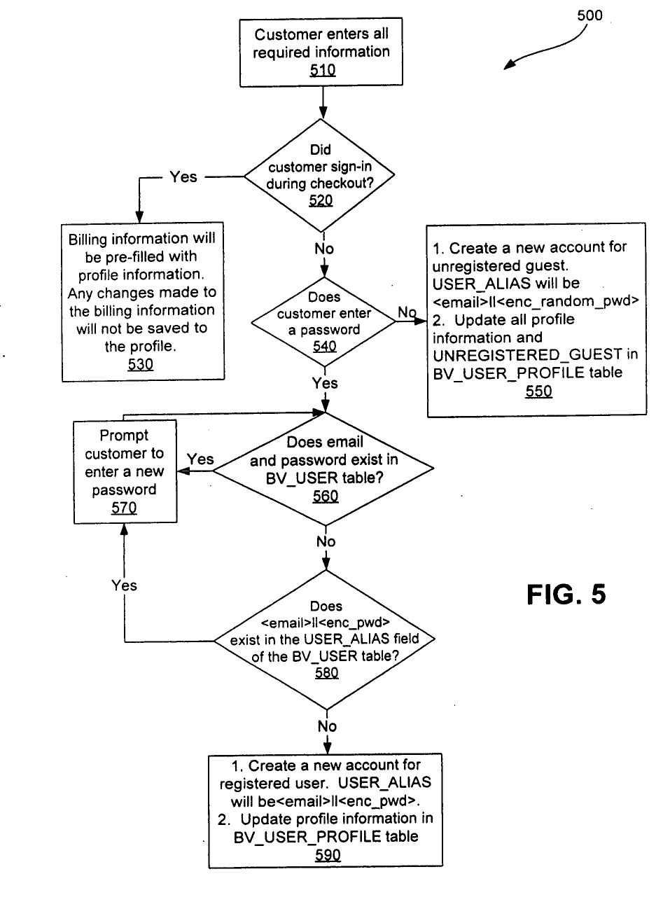

Referring now to FIG. 5 there is seen a schematic flow diagram, generally illustrated as 500, of logic employed by a computer system for a customer to check out after purchasing one or more products. The following logic will be performed by practice of embodiments of the logic flow diagram 500 of FIG. 5: (i)if a customer signed in during the checkout process, the checkout-information page will be loaded with all billing information pre-filled from customer's profile; (ii)if a customer did not sign in during the checkout process, the checkout-information page will be loaded with no billing information pre-filled, with the “Save profile” section will be displayed at the bottom of the page; (iii)if a customer clicks on the “hpshopping efinance” radio button, the checkout-information page will be reloaded without the option to change the shipping address (note: for e-Finance orders, the shipping information is typically the same as the billing information; (iv)the email field will be set to read-only for a customer who signed in during the checkout process; (v)there will be no email validation for a customer who signed in during the checkout process; (vi)the email field input will be available for a customer who did not sign in; (vii)if a customer selects “Credit Card” as preferred payment method and clicks on “shipping address” checkbox, the checkout-information page will be reloaded with billing and shipping information input fields; (viii)if a new customer enters a password in the “save profile” section, a check will be done to ensure that no email and password combination exists in the BV_USER table (note: if such combination exists, a customer will be prompted to enter a new password; (ix)once a customer clicks on “Continue with Checkout”, error checking will be done, the billing information will be saved to the profile, and if there are no errors, the customer will be taken to the review order page of the checkout process; (x) if a customer does not enter a password, a customer will be treated as unregistered user, the UNREGISTERED_USER column in the BV_USER_PROFILE will be set to 1 (the username convention for unregistered users is <email>_unregistered_<HP_UNREGISTERED_USER_SEQUENCE>||<enc_random_pwd>), and a customer will be “signed in” with the newly created account, but customer cannot tell that an account has been created (note: the top navigation bar may display “sign in” and “register” as if customer is still a guest); (xi)the bivisitor cookie will be 1 for customer who registers with a password during checkout; and (xii)the bivisitor cookie will be 0 or 2 for unregistered users, the cookie value will be 0 if customer has never been to web page site, and the cookie value will be 2 if customer is a returning “user”.

More specifically with respect to the logic flow diagram 500, in block 510 the customer enters billing information in a check out page which may be set forth or otherwise presented on one or more of the web pages 304 of the publishing system 303. When the check out page is suitably displayed, and after all required billing information has been entered, the logic flow diagram 500 proceeds to decision block 520 to determine if the customer signed-in during checkout. If the customer did sign-in during checkout, the logic flow proceeds to block 530 where billing information will be prefiled with profile information, and any changes made to the billing information will not be saved to the profile. If the customer did not sign-in during checkout, the logic flow proceeds to decision block 540 to determine whether or not the customer has entered a password. If the determination is negative or “no”, then the following procedures will be conducted: a new account will be created for an unregistered guest, USER_ALIAS will be set to <email>||<enc_random_pwd>, and update all profile information and UNREGISTERED_GUEST in BV_USER PROFILE table. If the determination by decision block 540 is positive or “yes”, then the logic flow proceeds to decision block 560 to determine if the email address and password exist in BV_USER table. If the determination in accordance with decision block 560 is positive, then a customer is prompted to enter a new password in accordance with block 570 and the logic flow proceeds back to decision block 560. If the determination in accordance with decision block 560 is negative or “no”, then the logic flow proceeds to decision block 580 for determining if <email>||<enc_random_pwd> exist in USER ALIAS field of BV_USER table. If <email>||<enc_random_pwd> does not exist in such field, then a new account will be created for a registered user, USER ALIAS will be <email>||<enc_random_pwd>, and profile information will be updated in the BV_USER_PROFILE table. If <email>||<enc_random_pwd> does exist in such field of BV_USER table, then the logic flow diagram proceeds to block 570 for prompting the customer to enter a new password.

Thus, by the practice of embodiments of the invention associated with the logic flow diagram 500 of FIG. 5, there will be a link at the top of the page that a registered customer can click to sign in. The page title and a short description for the checkout process will be displayed, and indicates the required fields that a customer needs to enter appropriate information. Under “product summary” products that have been added to the cart will be displayed. Those products can neither be removed nor modified on this page. The product name, quantity, and price for each product in the cart and subtotal will be displayed.

By the further practice of embodiments of the invention associated with the logic flow diagram 500 of FIG. 5, there are two payment-method options: credit card and finance (e.g., Hpshopping efinance). Credit card is the default payment method. If customer clicks on “hpshopping efinance” radio button for financing the electronic commerce purchase, a pop-up window with e-Finance address requirements are displayed and the checkout page is reloaded with no opportunity to modify the shipping information. There is also a pop-up for more information about electronic financing. The payment method is kept in the session until a customer changes it.

The billing address section allows a customer to enter billing information such as first and last name, address, city, state, zip code, and phone number. A customer who signed in during checkout has billing information filled from the profile. Billing information is saved in the profile for new registered users and unregistered users. An Email address is displayed as read-only for a customer who signed-in during checkout. An Email input field is available for new registered users and unregistered users. Typically, no email validation is done for a customer who signed in during checkout.

The shipping address section allows a customer to specify a shipping address different than the billing address. If customer clicks on the shipping address checkbox, customer is able to enter a different shipping address. By default, the shipping address is the same as the billing address. The information needed for shipping is the same as billing information. Generally, this section is not available if a customer selects “hpshopping efinance”.

The shipping method section allows a customer to be able to select a shipping option from drop-down list. The following are possible shipping options: two business days (ship default), next business day (ship normal), next business morning (ship express), Saturday Delivery (ship default Saturday) (if ordered on Thursday) and Saturday Delivery (ship express Saturday) (if ordered on Friday). Generally, a customer will be allowed to enter one coupon per order.

The save profile section allows a new customer to enter a password in order to register. If customer enters a password, he/she becomes a registered user. If customer does not enter a password, he/she is treated as an unregistered user. Typically, the save profile section will not be displayed to a customer who previously signed in during the checkout process.

The continue-with-checkout section is a short description indicating that the customer needs to click-on “Continue with Checkout” in order to proceed with the checkout process.

The associated scripts for embodiments of the invention illustrated in the logic flow diagram of FIG. 5 include checkout/checkout_info_view.jsp, checkout/checkout_info_control.jsp, and utils/checkout_info_utils.jsp

The information captured in embodiments of the invention illustrated in FIG. 5 is listed in the following Table IV:

TABLE IV

| | | Information | | |
|---|---|---|---|---|
| Element | Format | Source | Stored In | Comments |
| Sales Rep | Session | Home page | Session | Used to update the shopping cart |
| | | | variable | |
| Event type | User input | Form hidden | Html form | Used to determine whether customer wishes |
| | | input | | to edit shipping or billing information |
| Payment method | User input | Form radio | Html form | There are two options (credit card and e- |
| | | input | | Finance) |
| Coupon code | User input | Form text input | Html form | To apply discount if possible |
| Password | User input | Form password | Html form | N/A if customer previously signed in |
| | | input | | during checkout |
| Bill-to first | User input or | Form text input | Html form | Will not update BY USER PROFILE |
| name | database | | | |
| Bill-to last name | User input or | Form text input | Html form | Will not update BY USER PROFILE |
| | database | | | |
| Bill-to address | User input or | Form text input | Html form | Will not update BY USER PROFILE |
| | database | | | |
| Bill-to address2 | User input or | Form text input | Html form | Will not update BY USER PROFILE |
| | database | | | |
| Bill-to city | User input or | Form text input | Html form | Will not update BY USER PROFILE |
| | database | | | |
| Bill-to state | User input or | Form text input | Html form | Will not update BY USER PROFILE |
| | database | | | |
| Bill-to zip code | User input or | Form text input | Html form | Will not update BY USER PROFILE |
| | database | | | |
| Bill-to phone | User input or | Form text input | Html form | Will not update BY USER PROFILE |
| | database | | | |
| Shipping | User input | Form checkbox | Html form | N/A if “HP Financing” is selected |
| address different | | input | | |
| than billing | | | | |
| Ship-to first | User input or | Form text input | Html form | N/A if billing address is same as shipping |
| name | database | | | address or if “HP Financing “is selected |
| Ship-to last | User input or | Form text input | Html form | N/A if billing address is same as shipping |
| name | database | | | address or if “HP Financing “is selected |
| Ship-to address | User input or | Form text input | Html form | N/A if billing address is same as shipping |
| | database | | | address or if “HP Financing “is selected |
| Ship-to address2 | User input or | Form text input | Html form | N/A if billing address is same as shipping |
| | database | | | address or if “HP Financing “is selected |
| Ship-to city | User input or | Form text input | Html form | N/A if billing address is same as shipping |
| | database | | | address or if “HP Financing “is selected |
| Ship-to state | User input or | Form text input | Html form | N/A if billing address is same as shipping |
| | database | | | address or if “HP Financing “is selected |
| Ship-to zip code | User input or | Form select | Html form | N/A if billing address is same as shipping |
| | database | input | | address or if “HP Financing” is selected |
| Ship-to phone | User input or | Form text input | Html form | N/A if billing address is same as shipping |
| | database | | | address or if “HP Financing” is selected |
| Shipping option | User input | Form text input | Html form | Listing of available |

The information provided in embodiments of the invention illustrated in FIG. 5 is listed in the following Table V:

TABLE V

| Element | Format | Information Source | Stored In | Comments |
|---|---|---|---|---|
| Unregistered user | Session | Current page | Session | Will be used to identify order |
| | | | | coming from an unregistered |
| | | | | user for Business Intelligence |
| | | | | reporting |
| Bill-to first name | Session | Previous page | Session | Will not update |
| | | | bvi_properties | BV_USER_PROFILE |
| Bill-to last name | Session | Previous page | Session | Will not update |
| | | | bvi_properties | BV_USER_PROFILE |
| Bill-to address | Session | Previous page | Session | Will not update |
| | | | bvi_properties | BV_USER_PROFILE |
| Bill-to address2 | Session | Previous page | Session | Will not update |
| | | | bvi_properties | BV_USER_PROFILE |
| Bill-to city | Session | Previous page | Session | Will not update |
| | | | bvi_properties | BV_USER_PROFILE |
| Bill-to state | Session | Previous page | Session | Will not update |
| | | | bvi_properties | BV_USER_PROFILE |
| Bill-to zip code | Session | Previous page | Session | Will not update |
| | | | bvi_properties | BV_USER_PROFILE |
| Bill-to phone | Session | Previous page | Session | Will not update |
| | | | bvi_properties | BV_USER_PROFILE |
| Ship-to first name | Database | BV_DESTINATION_TABLE | NAME | N/A if billing address is same |
| | | | | as shipping address or if “HP |
| | | | | Financing” is selected |
| | | | | First and last name are |
| | | | | concatenated and separated |
| | | | | with a blank |
| Ship-to last name | Database | BV_DESTINATION_TABLE | NAME | N/A if billing address is same |
| | | | | as shipping address or if “HP |
| | | | | Financing” is selected |
| | | | | First and last name are |
| | | | | concatenated and separated |
| | | | | with a blank |
| Ship-to address | Database | BV_DESTINATION_TABLE | ADDRESS | N/A if billing address is same |
| | | | | as shipping address or if “HP |
| | | | | Financing” is selected |
| | | | | First and last name are |
| | | | | concatenated and separated |
| | | | | with a blank |
| Ship-to address2 | Database | BV_DESTINATION_TABLE | ADDRESS | N/A if billing address is same |
| | | | | as shipping address or if “HP |
| | | | | Financing” is selected |
| | | | | First and last name are |
| | | | | concatenated and separated |
| | | | | with a blank |
| Ship-to city | Database | BV_DESTINATION_TABLE | CITY | N/A if billing address is same |
| | | | | as shipping address or if “HP |
| | | | | Financing” is selected |
| | | | | First and last name are |
| | | | | concatenated and separated |
| | | | | with a blank |
| Ship-to state | Database | BV_DESTINATION_TABLE | STATE | N/A if billing address is same |
| | | | | as shipping address or if “HP |
| | | | | Financing” is selected |
| | | | | First and last name are |
| | | | | concatenated and separated |
| | | | | with a blank |
| Ship-to zip code | Database | BV_DESTINATION_TABLE | POSTAL_CODE | N/A if billing address is same |
| | | | | as shipping address or if “HP |
| | | | | Financing” is selected |
| | | | | First and last name are |
| | | | | concatenated and separated |
| | | | | with a blank |
| Ship-to phone | Database | BV_DESTINATION_TABLE | PHONE | N/A if billing address is same |
| | | | | as shipping address or if “HP |
| | | | | Financing” is selected |
| | | | | First and last name are |
| | | | | concatenated and separated |
| | | | | with a blank |
| Shipping option | Database | BV_DESTINATION_TABLE | SHIP_PRIORITY | N/A if billing address is same |
| | | | | as shipping address or if “HP |
| | | | | Financing” is selected |
| | | | | First and last name are |
| | | | | concatenated and separated |
| | | | | with a blank |

The navigation choices for embodiments of the invention illustrated in FIG. 4 is listed in the following Table VI:

TABLE VI

| Link Name | Format | Link To | Comments |
|---|---|---|---|
| Payment method | Form radio button | Same page | Can either select |
| | | | credit card or |
| | | | e-Financing |
| HP financing | Form radio button | Pop-up | Warning about |
| | | window | address |
| | | | requirements |
| Financing | Href image link | Pop-up | Description about |
| information | | window | e-Finance |
| Shipping address | Form checkbox | Same page | Ability to specify |
| different than | | | a different |
| billing | | | shipping address |
| | | | than billing |
| | | | address |
| Continue checkout | Form image input | Same page | Used for |
| | | | processing |
| Secure link | Href image link | | Description |
| | | | regarding |
| | | | secure connection |

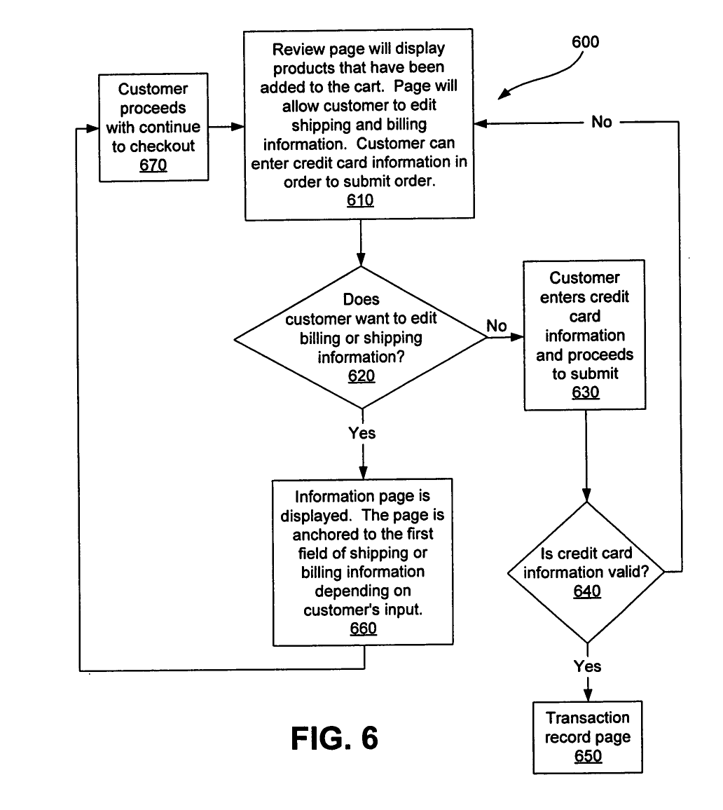

Referring now to FIG. 6 there is seen a schematic flow diagram, generally illustrated as 600, of logic employed by a computer system for a customer to review and submit an order page during check out after purchasing one or more products. The following logic will be performed by practice of embodiments of the logic flow diagram 600 of FIG. 6: (i)if customer clicks on the “Edit” button in the billing information section, the checkout information page will be displayed, and the anchor will be placed on the first field of the billing information section; (ii)if customer clicks on the “Edit” button in the shipping information section, the checkout information page will be displayed, and the anchor will be placed on the first field of the shipping information section; (iii)if a registered user clicks on the “click here to use a new credit card”, he/she will have the opportunity to enter new credit card information; (iv)if customer selects shipping address different than on the billing and credit card information that was previously saved, customer will be asked to re-enter credit card information for security reasons; (v)if customer enters credit card information and clicks on “submit” button, error checking will be done to ensure that all required fields have been properly filled out; (vi)if a customer is treated as an unregistered user in the checkout process, the section for remembering the credit card information will not be displayed; (vii)if a customer is treated as an unregistered user in the checkout process, the top navigation bar will display “sign in” and “register” as if the customer is still a guest; and (viii)if no errors have been found, the order will be sent to “Clear Commerce” and the final invoice page will be displayed.

More specifically with respect to the logic flow diagram 600, in block 610 the review page may be displayed, set forth or otherwise presented on one or more of the web pages 304 of the publishing system 303. When the review page is suitably displayed, products are displayed that have been added to the shopping cart. The review page will allow a customer to edit shipping and billing information, and the customer may enter credit card information in order to submit a purchase order. After the review page has been displayed, the logic flow diagram 600 proceeds to decision block 620 for the customer to determine whether or not he/she wants to edit billing or shipping information. If the determination by decision block 620 is a negative determination, that is, the customer does not wish to edit billing or shipping information, then the logic flow proceeds to block 630 for the customer to enter and submit credit card information. In accordance with decision block 640, a determination is made if the credit card information is valid. If it is not valid, the logic flow proceeds back to block 610. If it is valid, the logic flow proceeds to block 650 for display of the transaction record/final invoice page.

If the determination by decision block 620 is affirmative or “yes”; that is, the customer wants to edit billing or shipping information, then the logic flow proceeds to block 660 where the billing and shipping information page is displayed for the customer to accordingly edit. The billing and shipping page is anchored to the first field of shipping or billing information, depending on the customer's input. After the customer has edited the billing or shipping information page, the customer proceeds with continuing to checkout in accordance with block 670.

Thus, by practice of embodiments of the invention associated with the logic flow diagram of FIG. 6, a review and submit order page is created in which the customer may edit billing and/or shipping information. The page title and a short description for the review and submit order page is displayed, and indicates the required fields that customer needs to enter. Under the “Products Summary” section, products that have been added to the cart are displayed, along with the product name, quantity, price for each product, the subtotal cost, shipping cost, tax, and total cost for each and/or all products. Generally, these listed products can neither be removed nor modified on this web page.

The billing address section lists the billing information that was previously entered by the customer who will have the option to edit the billing information by clicking on the “Edit” button. The shipping address section lists the shipping information if the information is different than the billing information. Customer will have the option in the shipping address section to edit the shipping information by clicking on the “Edit” button. The shipping method section will display the shipping method selected by customer and will allow customer to edit it. In the place-your order section there will be a short description indicating that customer needs to click on “submit” button in order to proceed with the purchase.

The credit card information includes a select field for available credit card type, an input field for credit card number, a select field for credit card expiration month and a select field for expiration year, and a checkbox for the site to remember credit card information. Customer who signed in during the checkout process or new registered users has the option of saving credit card information. If a registered user previously saved credit card, the credit card information will be displayed as read-only with an option link to enter new credit card information. If a customer selects a shipping address which is different than a billing and credit card which was previously saved, the customer will be asked to re-enter credit card information for security reasons.

The associated scripts for embodiments of the invention illustrated in the logic flow diagram of FIG. 6 include checkout/checkout_order_view.jsp, checkout/checkout_order_control.jsp, and utils/payment_utils.jsp.

The information captured in embodiments of the invention illustrated in FIG. 6 is listed in the following Table VII:

TABLE VII

| | | | | |
|---|---|---|---|---|
| Unregistered | Session | Previous page | Session | Will be used to |
| user | | | | identify order coming |
| | | | | from an unregistered |
| | | | | user for Business |
| | | | | Intelligence reporting |
| Sales Rep | Session | Home page | Session | Used to update the |
| | | | | shopping cart |
| Bill-to first | Session | Previous page | Session bvi- | |
| name | | | properties | |
| Bill-to last | Session | Previous page | Session bvi- | |
| name | | | properties | |
| Bill-to address | Session | Previous page | Session bvi- | |
| | | | properties | |
| Bill-to address2 | Session | Previous page | Session bvi- | |
| | | | properties | |
| Bill-to city | Session | Previous page | Session bvi- | |
| | | | properties | |
| Bill-to state | Session | Previous page | Session bvi- | |
| | | | properties | |
| Bill-to zip code | Session | Previous page | Session bvi- | |
| | | | properties | |
| Bill-to phone | Session | Previous page | Session bvi- | |
| | | | properties | |
| Ship-to first | Database | BV_DESTINATION_TABLE | NAME | N/A if billing address |
| name | | | | is same as shipping |
| | | | | addressFirst and last name |
| | | | | are concatenated and |
| | | | | separated with a ‘\|’ |
| Ship-to last | Database | BV_DESTINATION_TABLE | NAME | N/A if billing address |
| name | | | | is same as shipping |
| | | | | addressFirst and last name |
| | | | | are concatenated and |
| | | | | separated with a ‘\|’ |
| Ship-to address | Database | BV_DESTINATION_TABLE | ADDRESS | N/A if billing address |
| | | | | is same as shipping |
| | | | | addressFirst and last name |
| | | | | are concatenated and |
| | | | | separated with a ‘\|’ |
| Ship-to | Database | BV_DESTINATION_TABLE | ADDRESS | N/A if billing address |
| address2 | | | | is same as shipping |
| | | | | addressFirst and last name |
| | | | | are concatenated and |
| | | | | separated with a ‘\|’ |
| Ship-to city | Database | BV_DESTINATION_TABLE | CITY | N/A if billing address |
| | | | | is same as shipping |
| | | | | address |
| Ship-to state | Database | BV_DESTINATION_TABLE | STATE | N/A if billing address |
| | | | | is same as shipping |
| | | | | address |
| Ship-to zip code | Database | BV_DESTINATION_TABLE | POSTAL_CODE | N/A if billing address |
| | | | | is same as shipping |
| | | | | address |
| Ship-to phone | Database | BV_DESTINATION_TABLE | PHONE | N/A if billing address |
| | | | | is same as shipping |
| | | | | address |
| | | | | 4 fix-sized sub fields |
| | | | | are concatenated |
| | | | | without any separator |
| Shipping option | Database | BV_DESTINATION_TABLE | SHIP_PRIORITY | |
| Credit card type | User input or | Form select input | Html form | |
| | database | | | |
| Credit card | User input or | Form text input | Html form | Will display last |
| number | database | | | digits and ‘x’ for |
| | | | | others if from |
| | | | | database |
| Expiration | User input or | Form select input | Html form | |
| month | database | | | |
| Expiration year | User input or | Form select input | Html form | |
| | database | | | |
| Save credit card | User input or | Form checkbox input | Html form | |
| | database | | | |

The information provided in embodiments of the invention illustrated in FIG. 6 is listed in the following Table VIII:

TABLE VIII

| Element | Format | Information Source | Stored In | Comments |
|---|---|---|---|---|
| Credit card type | Database | BV_PAYMENT | PAYMENT_TYPE | |
| Credit card number | Database | BV_PAYMENT | CARD_NUM | |
| Expiration month | Database | BV_PAYMENT | EXP_DATE | |
| Expiration year | Database | BV_PAYMENT | EXP_DATE | |
| Save credit card | Database | BV_PAYMENT | REMEMBER_CC | |

The navigation choices provided in embodiments of the invention illustrated in FIG. 6 is listed in the following Table IX:

TABLE IX

| Link Name | Format | Link To | Comments |
|---|---|---|---|
| Edit billing info | Href image link | Information page | For changing |
| | | | billing info |
| Edit shipping info | Href image link | Information page | For changing |
| | | | shipping info |
| Secure link | Href image link | Pop-up window | Description |
| | | | regarding |
| | | | secure |
| | | | connection |
| | | | Submit |
| Submit | Form image input | Same page | Used for |
| | | | processing |

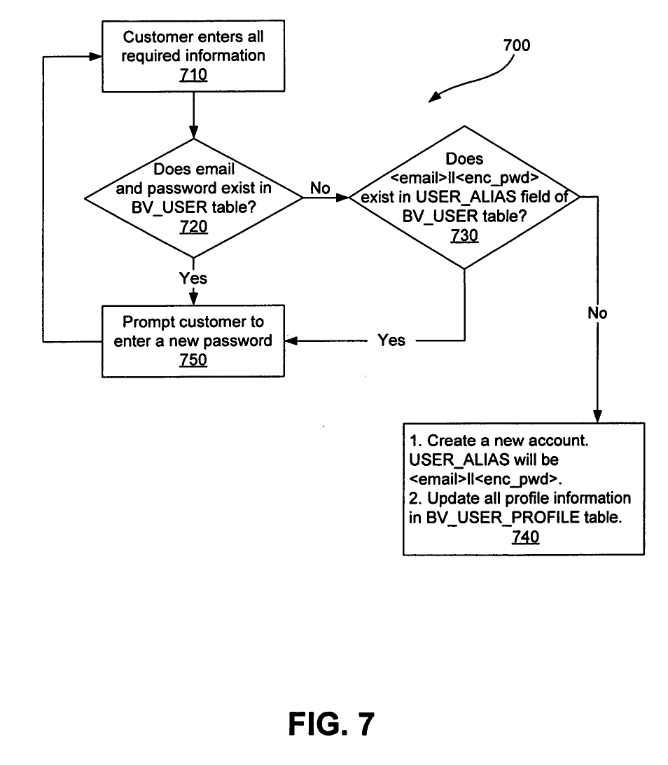

Referring now to FIG. 7 there is seen a schematic flow diagram, generally illustrated as 700, of logic employed by a computer system for a customer to register, more particularly a registration process for a customer (e.g., a regular user). The following logic will be performed by practice of embodiments of the logic flow diagram 700 of FIG. 7: (i)script will ensure that all required fields have been filled out; (ii)if customer enters an email address and a password combination that already exists in the BV_USER table, he/she is prompted to enter a new password; (iii) if customer enters valid information, a new account is created, the USER_ALIAS is updated with <email>||<encrypted password> in the BV_USER table, and all profile information is saved in the BV_USER_PROFILE table; and (iv)the bivisitor cookie is 1 for a customer who successfully registers.

More specifically with respect to the logic flow diagram 700, for the instructions in block 710 to be appropriately performed a suitable page with appropriate fields may be displayed, set forth or otherwise presented on one or more of the web pages 304 of the publishing system 303. After a suitable page has been displayed, a customer enters all required information in accordance with block 710. From block 710 the logic flow proceeds to decision block 720 to determine if the customer email and password exist in the BV_USER table. If the determination of decision block 720 is negative or “no”, then the logic flow proceeds to decision block 730 to determine if <email>||<encrypted password> exist in the USER_ALIAS field of the BV_USER table. If the determination of decision block 730 is negative or “no”, then in accordance with block 740 a new customer account is created, with USER_ALIAS becoming <email>||<encrypted password>, and all profile information being updated in BV_USER_PROFILE table.

If the determination of decision block 720 or decision block 730 is positive or “yes”, then the customer is prompted to enter a new password in accordance with block 750. After entering a new password is entered by the customer, the logic flow diagram 700 of FIG. 7 proceeds back to block 710.

Thus, by practice of embodiments of the invention associated with the logic flow diagram of FIG. 7, a registration is created or performed for a customer. A page is displayed with a title and a short description describing the registration process. All required fields are identified, and there is a link for a registered user to sign-in. The sign-in section requires a customer to enter an email address, password, and password confirmation. This information is used to create an account.

The profile information section requires a customer to enter in appropriate fields first and last name, address, city, state, zip code, and phone number. A customer may enter a second line in the address field but this field is optional. For various embodiments of the invention (e.g., hpshopping) a customer has the option to have his/her credit card information remembered. In the registration process for various embodiments of the invention a customer can click the “Register” button to submit the information, and there is also be a link to a “security” page.

The associated scripts for embodiments of the invention illustrated in the logic flow diagram of FIG. 7 include profile/register_view.jsp, profile/register_control.jsp, and utils/info_check_utils.jsp.

The information captured in embodiments of the invention illustrated in FIG. 7 is listed in the following Table X:

TABLE X

| Element | Format | Information Source | Stored In | Comments |
|---|---|---|---|---|
| Email | User input | Form text input | Html form | Used to create account |
| Password | User input | Form password input | Html form | Used to create account |
| Confirm password | User input | Form text input | Html form | Used to validate |
| | | | | password |
| First name | User input | Form text input | Html form | Used to update profile |
| Last name | User input | Form text input | Html form | Used to update profile |
| Address | User input | Form text input | Html form | Used to update profile |
| Address2 | User input | Form text input | Html form | Used to update profile |
| City | User input | Form text input | Html form | Used to update profile |
| State | User input | Form select | Html form | Used to update profile |
| Zip code | User input | Form text input | Html form | Used to update profile |
| Phone | User input | Form text input | Html form | Used to update profile |
| Remember credit | User input | Form checkbox | Html form | Used to update profile |
| card information | | | | |
| Flag to distinguish | Query | Registration link | Request.value | Used to distinguish |
| profile vs. | string | | | between new registration |
| registration | | | | vs. edit profile text |

The information provided in embodiments of the invention illustrated in FIG. 7 is listed in the following Table XI:

TABLE XI

| Element | Format | Information Source | Stored In | Comments |
|---|---|---|---|---|
| Email | Database | BV_USER | USER_ALIAS | Use<email>∥<encrypted |
| | | | | password> to update |
| | | | | user_alias |
| Password | Database | BV_USER | PASSWORD | Use<email>∥<encrypted |
| | | | | password> to update |
| | | | | user_alias |
| First name | Database | BV_USER_PROFILE | FIRST_NAME | Used to update profile |
| Last name | Database | BV_USER_PROFILE | LAST_NAME | Used to update profile |
| Address | Database | BV_USER_PROFILE | ADDRESS | Used to update profile |
| Address2 | Database | BV_USER_PROFILE | ADDRESS2 | Used to update profile |
| City | Database | BV_USER_PROFILE | CITY | Used to update profile |
| State | Database | BV_USER_PROFILE | STATE | Used to update profile |
| Zip code | Database | BV_USER_PROFILE | ZIP_CODE | Used to update profile |
| Phone | Database | BV_USER_PROFILE | DAY_TELEPHONE | Used to update profile |
| Remember | Database | BV_USER_PROFILE | REMEMBER_CC | Used to update profile |
| credit card | | | | |
| information | | | | |
| Phone | Database | BV_USER_PROFILE | DAY_TELEPHONE | Used to update profile |
| BI cookie | Session | Current page | Session variable | Used for Business |
| variable | | | | Intelligence reporting |

The navigation choices provided in embodiments of the invention illustrated in FIG. 7 is listed in the following Table XII:

TABLE XII

| Link Name | Format | Link To | Comments |
|---|---|---|---|
| Credit card link | Href image link | Pop-up | Credit card |
| | | window | security message |
| Secure link | Href image link | Pop-up | Secure |
| | | window | connection message |
| Register link | Form image input | Same page | Used for processing |

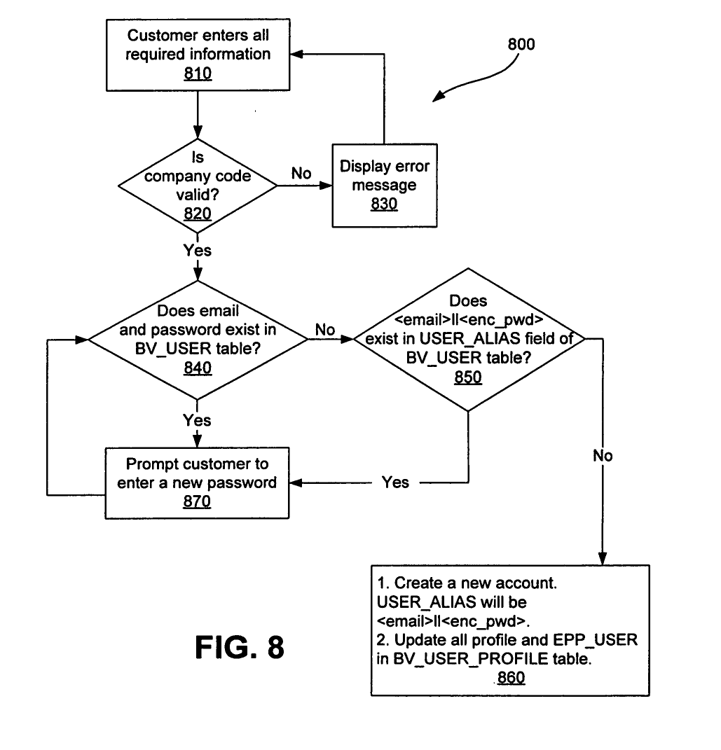

Referring now to FIG. 8 there is seen a schematic flow diagram, generally illustrated as 800, of logic employed by a computer system for another embodiment of the invention for a customer to register, more particularly a registration process for EPP/APP customers. The following logic will be performed by practice of embodiments of the logic flow diagram 800 of FIG. 8: (i)script will ensure that all required fields have been filled out; (ii)if a customer enters an email address and a password that already exists in the BV_USER table, he/she will be prompted to enter a new password for security reasons; (iii)if customer enters all required information and a valid company code, a new account will be created, along with the USER_ALIAS being updated with <email>||<encrypted password> in the BV_USER table, and all profile information being saved in the BV_USER_PROFILE table; and (iv)the bivisitor cookie is 1 for EPP/APP customers who successfully register.

More specifically with respect to the logic flow diagram 800, for the instructions in block 810 to be appropriately performed a suitable page with appropriate fields may be displayed, set forth or otherwise presented on one or more of the web pages 304 of the publishing system 303. After a suitable page has been displayed, an EPP/APP customer enters all required information in accordance with block 810. From block 810 the logic flow proceeds to decision block 820 to determine if the company code is valid. If it is not, an error message is displayed as indicated by block 830. If the company code is valid, then a determination is made (as indicated by decision block 840) if the customer email and password exist in the BV_USER table. If the determination of decision block 820 is negative or “no”, then the logic flow proceeds to decision block 850 to determine if <email>||<encrypted password> exist in the USER_ALIAS field of the BV_USER table. If the determination of decision block 850 is negative or “no”, then in accordance with block 860 a new customer account is created, with USER ALIAS becoming <email>||<encrypted password>, and all profile information being updated in BV_USER_PROFILE table.

If the determination of decision block 840 or decision block 850 is positive or “yes”, then the EPP/APP customer is prompted to enter a new password in accordance with block 870. After a new password is entered by the customer, the logic flow diagram 800 of FIG. 8 proceeds back to block 840.

Thus, by practice of embodiments of the invention associated with the logic flow diagram of FIG. 8, a registration is created or performed for EPP/APP customers. A page is displayed having a title and a short description describing the EPP/APP registration process and having the identification of all required fields. The user information section requires an EPP/APP customer to enter in appropriate fields first and last name, email, password, confirm password, and company code. This information is used to create an EPP/APP account. To complete the registration process the EPP/APP customer can click the “Register” button to submit the information and click the “Clear” button to reset the information.

The associated scripts for embodiments of the invention illustrated in the logic flow diagram of FIG. 8 include epp/logon/epp-register_view.jsp, and epp/logon/epp-register_control.jsp.

The information captured in embodiments of the invention illustrated in FIG. 8 is listed in the following Table XIII:

TABLE XIII

| Element | Format | Information Source | Stored In | Comments |
|---|---|---|---|---|
| Email | User input | Form text input | Html form | Used to |
| | | | | create |
| | | | | account |
| Password | User input | Form password input | Html form | Used to |
| | | | | create |
| | | | | account |
| Confirm | User input | Form text input | Html form | Used to |
| password | | | | validate |
| | | | | password |
| First name | User input | Form text input | Html form | Used to |
| | | | | update |
| | | | | profile |
| Last name | User input | Form text input | Html form | Used to |
| | | | | update |
| | | | | profile |

The information provided in embodiments of the invention illustrated in FIG. 8 is listed in the following Table XIV:

TABLE XIV

| Element | Format | Information Source | Stored In | Comments |
|---|---|---|---|---|
| Email | Database | BV_USER | USER_ALIAS | Use<email>∥<encrypted |
| | | | | password> to update |
| | | | | user alias |
| Password | Database | BV_USER | PASSWORD | Used to update bv_user |
| | | | | table |
| First name | Database | BV_USER_PROFILE | FIRST_NAME | Used to update profile |
| Last name | Database | BV_USER_PROFILE | LAST_NAME | Used to update profile |
| EPP user flag | Database | BV_USER_PROFILE | EPP_USER | Used to update profile |
| EPP company | Database | BV_USER_PROFILE | EPP_CIC | Used to update profile |
| CIC | | | | |
| BI cookie | Session | Current page | Session variable | Used for Business |
| variable | | | | Intelligence reporting |

The navigation choices provided in embodiments of the invention illustrated in FIG. 8 is listed in the following Table XV:

TABLE XV

| Link Name | Format | Link To | Comments |
|---|---|---|---|
| Register | Form submit | Same page | Used for |
| | button | | processing form |
| Clear | Form reset | Same | Clears all |
| | | | information in form |

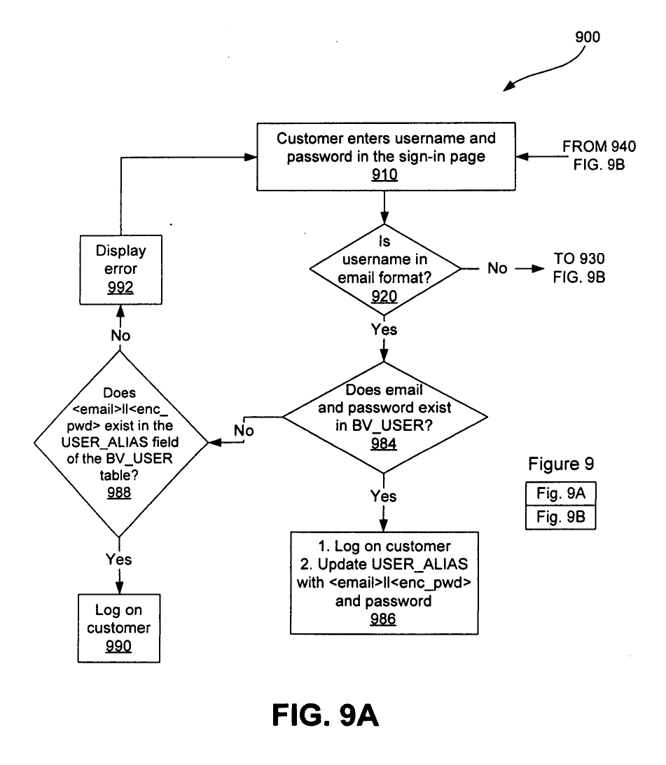

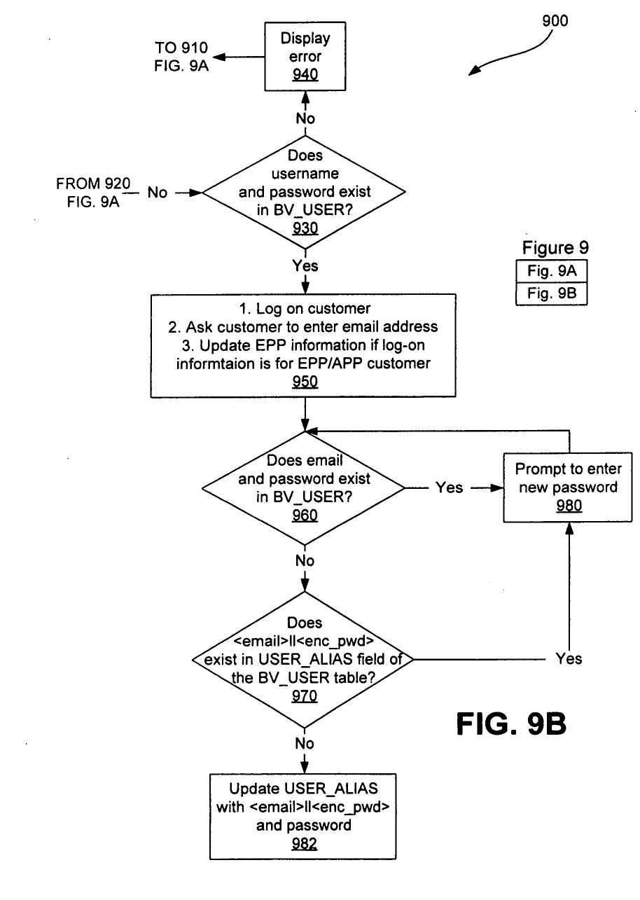

Referring now to FIG. 9 there is seen a schematic flow diagram, generally illustrated as 900, of logic employed by a computer system for another embodiment of the invention for a customer to sign in, more particularly a sign-in process for regular-user customers. The following logic will be performed by practice of embodiments of the logic flow diagram 900 of FIG. 9: (i) a regular-user customer enters a username and password in the sign-in page after it has been appropriately displayed; (ii)if the customer enters invalid data, an error message is displayed; (iii)if the customer enters a username different than the customer's email address, the customer is asked to enter a new and/or valid email address; (iv) if the customer enters a valid email address, and if the email address and password for the customer already exists, the customer will be asked to enter a new password; (v) if the email address and password for the customer does not already exists, the USER_ALIAS field will be updated with <email>||<encrypted password> in the BV_USER table; and (vi) the bivisitor cookie will be 3 for the customer who successfully signs in.

More specifically with respect to the logic flow diagram 900, for the instructions in block 910 to be appropriately performed a suitable page (e.g., a sign-in page) with appropriate fields may be displayed, set forth or otherwise presented on one or more of the web pages 304 of the publishing system 303. After the suitable page has been displayed, a customer (e.g., regular user customer) enters username and password in the sign-in page in accordance with block 910. From block 910 the logic flow proceeds to decision block 920 to determine if the username is in email format. If it is not, the logic flow proceeds to decision block 930 for determining if the username and password exist in the BV_USER table. If they do not exist in the BV_USER table, an error message is displayed as indicated by block 940. If they do exist in the BV_USER table, the logic flow proceeds to block 950 for logging-on the customer, asking the customer to enter an email address, and updating EPP information if the log-on information is for EPP/APP customer. After the instructions of block 950 have been performed, a determination is made if the email and password exist in the BV_USER table (e.g., see decision block 960). If they do not exist in the BV_USER table, a determination is made in accordance with decision block 970 if the <email>||<encrypted password> exists in the USER_ALIAS field of the BV_USER table. An affirmative determination by decision block 970 prompts a customer to enter a new password as indicated by block 980 and the logic flow returns to decision block 960. If decision block 970 produces a negative or “no” determination, the USER_ALIAS is updated with <email>||<encrypted password> and the password in accordance with block 982.

Referring now again to decision block 920, if a positive determination is produced by decision block 920, the logic flow proceeds to decision block 984 to determine if the email and password exist in the BV_USER table. If they do exist, the customer is logged-on and the USER_ALIAS is updated with <email>||<encrypted password> and the password in accordance with block 986. If the email and password do not exist in the BV_USER table, the logic flow proceeds to decision block 988 to determine if the <email>||<encrypted password> exists in the USER_ALIAS field of the BV_USER table. If the <email>||<encrypted password> exists in the USER_ALIAS field of the BV_USER table, then the customer is logged-on in accordance with block 990. If the <email>||<encrypted password> does not exists in the USER_ALIAS field of the BV_USER table, an error is displayed per block 992 and the logic flow proceeds back to block 910.

Thus, by practice of embodiments of the invention associated with the logic flow diagram 900 of FIG. 9, a sign-in procedure is conducted or performed for regular-user customers. A page is displayed having a title and a short description describing the sign-in process and having the all required fields identified. The customer is required to enter a username and password in order to sign in, and there are links to the “forgot password” and “security” pages.

The associated scripts for embodiments of the invention illustrated in the logic flow diagram of FIG. 9 include profile/signin_view.jsp, profile/signin_control.jsp, profile/convert_username_view.jsp, and profile/convert_username_control.jsp.

The information captured in embodiments of the invention illustrated in FIG. 9 is listed in the following Table XVI:

TABLE XVI

| Element | Format | Information Source | Stored In | Comments |
|---|---|---|---|---|
| User name | User input | Form test input | Html form | Used to |
| | | | | sign in |
| Password | User input | Form password input | Html form | Used to |
| | | | | sign in |

The information provided in embodiments of the invention illustrated in FIG. 9 is listed in the following Table XVII:

TABLE XVII

| Element | Format | Information Source | Stored In | Comments |
|---|---|---|---|---|
| Salesrep | Session | Homepage | Session | Used to transfer |
| | | | | shopping cart to |
| | | | | registered customer |
| User type | Session | Checkout login page | Cookie | Used to distinguish |
| | | | | registered vs. |
| | | | | unregistered |
| Greeting | Session | BV_USER_PROFILE | Cookie | Used to display name at |
| | | | | the top navbar |
| User id | Session | BV_USER | Cookie | Used to automatically |
| | | | | sign in customer |
| Cart id | Session | Database sequence | Cookie | Used to display |
| | | | | persistent shopping cart |
| Diff user | Session | Homepage | Session | Used to decide whether |
| | | | | or not the persistent cart |
| | | | | should be transferred |
| Hpcart | Session | Homepage | Session | Persistent shopping cart |
| Directory | Session | HP_EPP_COMPANY | DIRECTORY | Used for EPP customer |
| Company name | Session | HP_EPP_COMPANY | NAME | Used for EPP customer |
| Company id | Session | HP_EPP_COMPANY | COMPANY_ID | Used for EPP customer |
| Company cic | Session | HP_EPP_COMPANY | CIC | Used for EPP customer |
| BI cookie | Session | Current page | Session variable | Used for Business |
| variable | | | | Intelligence reporting |

The navigation choices provided in embodiments of the invention illustrated in FIG. 9 is listed in the following Table XVIII:

TABLE XVIII

| Link Name | Format | Link To | Comments |
|---|---|---|---|
| Secure link | Href link | Pop-up window | Security |
| | | | page |
| Sign in | Form submit button | Same page | |
| Clear form | Href image link | Same page | Resets |
| | | | the form |
| Secure link | Href text link | Forgot password page | |

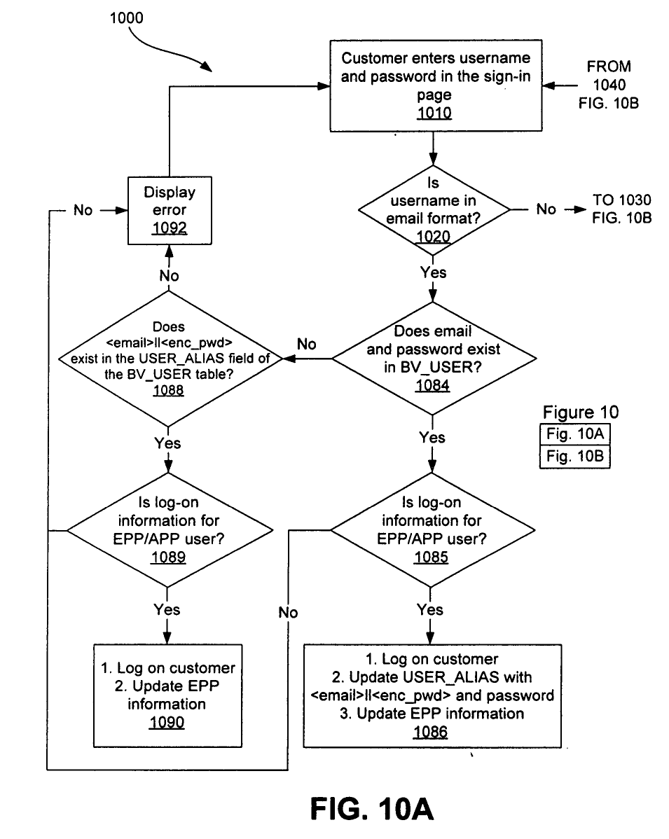

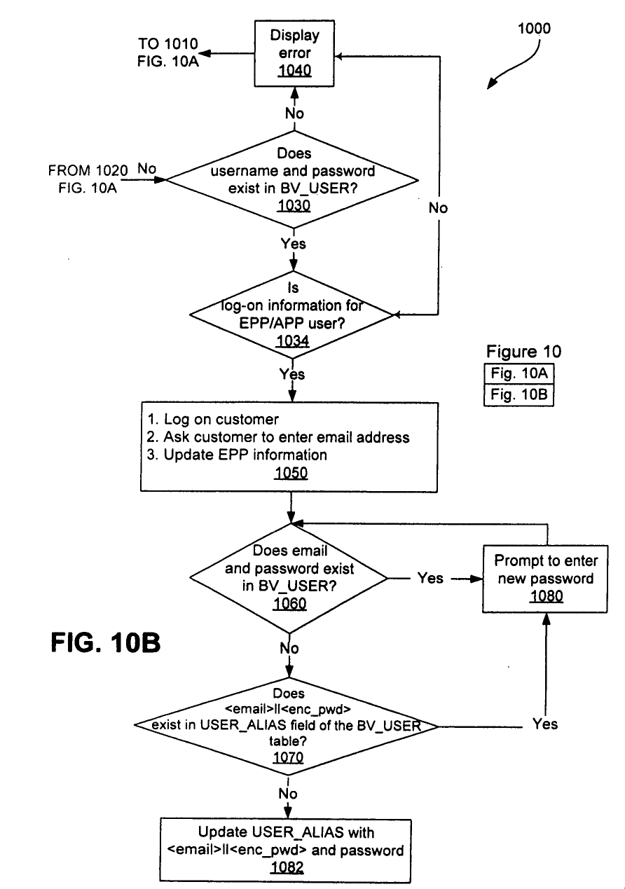

Referring now to FIG. 10 there is seen a schematic flow diagram, generally illustrated as 1000, of logic employed by a computer system for another embodiment of the invention for a customer to sign-in, more particularly a sign-in process for EPP-user customers. The following logic will be performed by practice of embodiments of the logic flow diagram 1000 of FIG. 10: (i) an EPP customer enters a username and password in the sign-in page after it has been appropriately displayed; (ii)if the customer enters invalid data, an error message is displayed; (iii)if the customer enters a username different than the customer's email address, the customer is asked to enter a new and/or valid email address; (iv)if the customer enters a valid email address, and if the email address and password for the customer already exists, the customer will be asked to enter a new password; (v)if the email address and password for the customer does not already exists, the USER_ALIAS field will be updated with <email>||<encrypted password> in the BV_USER table; and (vi)the bivisitor cookie will be 3 for the customer who successfully signs-in.

More specifically with respect to the logic flow diagram 1000, for the instructions in block 1010 to be appropriately performed a suitable page (e.g., a sign-in page) with appropriate fields may be displayed, set forth or otherwise presented on one or more of the web pages 304 of the publishing system 303. After the suitable page has been displayed, a customer (e.g., an EPP customer) enters username and password in the sign-in page in accordance with block 1010. From block 1010 the logic flow proceeds to decision block 1020 to determine if the username is in email format. If it is not, the logic flow proceeds to decision block 1030 for determining if the username and password exist in the BV_USER table. If they do not exist in the BV_USER table, an error message is displayed as indicated by block 1040. If they do exist in the BV_USER table, the logic flow proceeds to block 1034 to determine if log-on information is for an EPP/APP user/customer. If the log-on information is not for an EPP/APP user/customer, the logic flow proceeds display-error block 1040. If the log-on information is for an EPP/APP user/customer the logic flow proceeds to block 1050 for logging-on the customer, asking the customer to enter an email address, and updating EPP information since the log-on information is for EPP/APP customer. After the instructions of block 1050 have been performed, a determination is made if the email and password exist in the BV_USER table (e.g., see decision block 1060). If they do not exist in the BV_USER table, a determination is made in accordance with decision block 1070 if the <email>||<encrypted password> exists in the USER_ALIAS field of the BV_USER table. An affirmative determination by decision block 1070 prompts a customer to enter a new password as indicated by block 1080 and the logic flow returns to decision block 1060. If decision block 1070 produces a negative or “no” determination, the USER_ALIAS is updated with <email>||<encrypted password> and the password in accordance with block 1082.

Referring now again to decision block 1020, if a positive determination is produced by decision block 1020, the logic flow proceeds to decision block 1084 to determine if the email and password exist in the BV_USER table. If they do exist in the BV_USER table, the logic flow proceeds to block 1085 to determine if log-on information is for an EPP/APP user/customer. If the log-on information is not for an EPP/APP user/customer, the logic flow proceeds display-error block 1092. If the log-on information is for an EPP/APP user/customer the logic flow proceeds to block 1086 for logging-on the customer, updating the USER_ALIAS with <email>||<encrypted password> and the password in accordance with block 1086. If the email and password do not exist in the BV_USER table, the logic flow proceeds to decision block 1088 to determine if the <email>||<encrypted password> exists in the USER_ALIAS field of the BV_USER table. If the <email>||<encrypted password> exists in the USER_ALIAS field of the BV_USER table, then the logic flow proceeds to block 1089 to determine if log-on information is for an EPP/APP user/customer. If the log-on information is not for an EPP/APP user/customer, the logic flow proceeds display-error block 1092. If the log-on information is for an EPP/APP user/customer, the logic flow proceeds to block 1090 for logging-on the customer, updating the EPP information.

Thus, by practice of embodiments of the invention associated with the logic flow diagram 1000 of FIG. 10, a sign-in procedure is conducted or performed for EPP-user customers. A page is displayed having a title and a short description describing the sign-in process and having the all required fields identified. The EPP customer is required to enter a username and password in order to sign in, and there are links to the “forgot password” and “security” pages.

The associated scripts for embodiments of the invention illustrated in the logic flow diagram of FIG. 10 include epp/logon/epp_signin_view.jsp, epp/logon/epp_signin_control.jsp, profile/convert_username view.jsp, and profile/convert_username_control.jsp.

The information captured in embodiments of the invention illustrated in FIG. 10 is listed in the following Table XIX:

TABLE XIX

| Element | Format | Information Source | Stored In | Comments |
|---|---|---|---|---|
| User name | User input | Form text input | Html form | Used to |
| | | | | sign in |
| Password | User input | Form password input | Html form | Used to |
| | | | | sign in |

The information provided in embodiments of the invention illustrated in FIG. 10 is listed in the following Table XX:

TABLE XX

| | | | | |
|---|---|---|---|---|
| Salesrep | Session | Homepage | Session | Used to transfer |
| | | | | shopping cart to |
| | | | | registered customer |
| User type | Session | Checkout login page | Cookie | Used to distinguish |
| | | | | registered vs. |
| | | | | unregistered |
| Greeting | Session | BV_USER_PROFILE | Cookie | Used to display name at |
| | | | | the top navbar |
| User id | Session | BV_USER | Cookie | Used to automatically |
| | | | | sign in customer |
| Cart id | Session | Database sequence | Cookie | Used to display |
| | | | | persistent shopping cart |
| Diff user | Session | Homepage | Session | Used to decide whether |
| | | | | or not the persistent cart |
| | | | | should be transferred |
| Hpcart | Session | Homepage | Session | Persistent shopping cart |
| Company name | Session | HP_EPP_COMPANY | | Used to display |
| | | | | company name |
| Company id | Session | HP_EPP_COMPANY | | Used to display |
| | | | | company banner |
| Company cic | Session | HP_EPP_COMPANY | | |
| BI cookie | Session | Current page | Session | Used for Business |
| variable | | | variable | Intelligence reporting |

The navigation choices provided in embodiments of the invention illustrated in FIG. 10 is listed in the following Table XXI:

TABLE XXI

| Link Name | Format | Link To | Comments |
|---|---|---|---|
| Sign in | Form submit button | Same page | |
| Clear form | Href image link | Same page | |

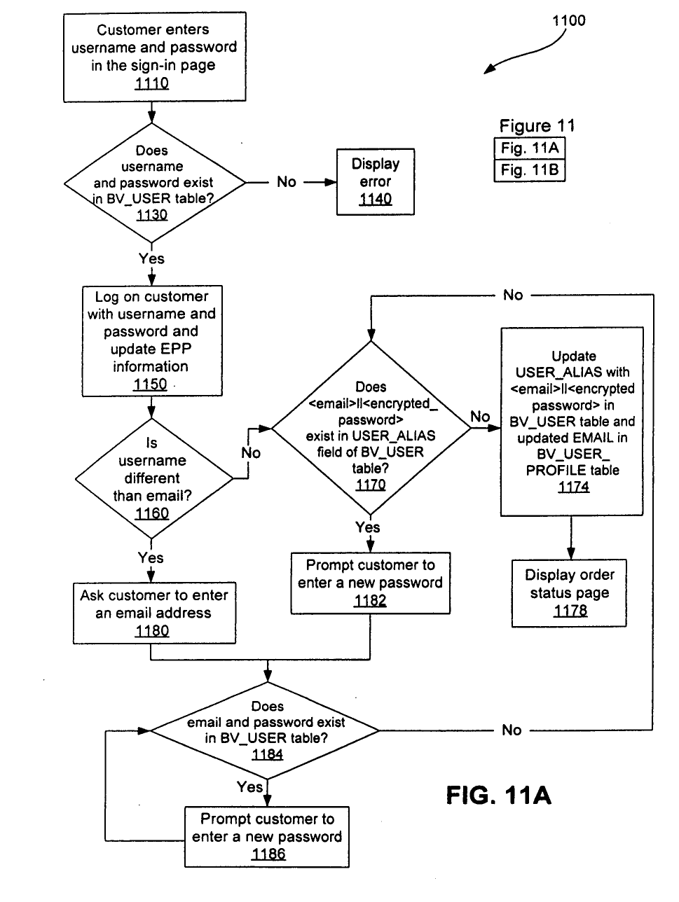

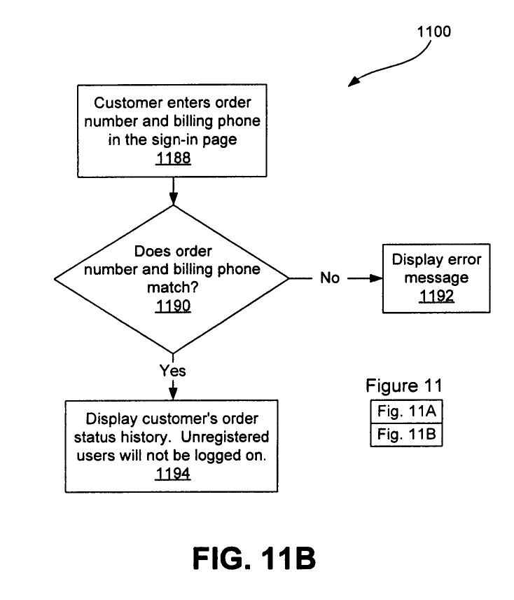

Referring now to FIG. 11 there is seen a schematic flow diagram, generally illustrated as 1100, of logic employed by a computer system for another embodiment of the invention for a customer to sign-in, more particularly a sign-in process for regular and EPP-user customers. The following logic will be performed by practice of embodiments of the logic flow diagram 1100 of FIG. 11: (i) a customer (e.g., regular and EPP users) enters a username and password in the sign-in page after it has been appropriately displayed; (ii)if the customer enters invalid data, an error message is displayed; (iii)if the customer enters a username different than the customer's email address, the customer is asked to enter a new and/or valid email address; (iv)if the customer enters an invalid order number and phone number in the sign-in page, an error message will be displayed; (v)if the order number and phone number are valid, the customer will be able to view his/her order status history (note: for unregistered user orders, customer will not be logged-on); (vi)the bivisitor cookie will be 3 for the customer who successfully signs-in; and (vii)the bivisitor cookie will be 0 or 2 for unregistgered users, with the cookie value being 0 if the customer has never been to the site of the company or vendor and with the cookie value being 2 if the customer is a returning user or the site.

More specifically with respect to the logic flow diagram 1100, for the instructions in block 1110 to be appropriately performed a suitable page (e.g., a sign-in page) with appropriate fields may be displayed, set forth or otherwise presented on one or more of the web pages 304 of the publishing system 303. After the suitable page has been displayed, a customer (e.g., a regular and EPP user customer) enters username and password in the sign-in page in accordance with block 1110. From block 1110 the logic flow proceeds to decision block 1130 to determine if the username and password exist in the BV_USER table. If they do not exist in the BV_USER table, an error message is displayed as indicated by block 1140. If they do exist in the BV_USER table, the logic flow proceeds to block 1150 for logging-on the customer with username and password, and updating EPP information since the log-on information is for a regular and EPP customer. After the instructions of block 1150 have been performed, a determination is made in accordance with decision block 1160. If the determination of decision block 1160 is negative or “no”, then the logic flow proceeds to decision block 1170 to determine if the <email>||<encrypted password> exists in the USER ALIAS field of the BV_USER table. If decision block 1170 produces a negative or “no” determination, the USER_ALIAS is updated with <email>||<encrypted password> and the password, and the order is displayed on the status page, respectively, in accordance with block 1174 and block 1178.

An affirmative determination by decision block 1160 and decision block 1070, respectively, asks the customer to enter an email address (see instructions in block 1180) and prompts a customer to enter a new password as indicated by block 1182, and the logic flow proceeds to decision block 1184 for determining if the email and password exist in the BV_USER table. If the determination by decision block 1184 is negative or “no”, then the logic flow proceeds back to decision block 1170. If the determination by decision block 1184 is positive or “yes”, then the customer is prompted to enter a new password in accordance with the instructions in block 1186.

Referring now to the instructions in block 1188 and further referencing the sign-in page, the customer enters order number and billing phone number in the sign-in page, and subsequently, a determination is to be made in accordance with decision block 1190 if the order number matches or is consistent with the billing phone number of the customer. Stated alternatively, a determination is made if the customer for the order number is the same customer for the billing phone number. If the determination by decision block 1190 is negative or “no”, an error message is displayed as indicated by block 1192, If the determination by decision block 1190 is affirmative or “yes”, the instructions of block 1194 are conducted; that is, the order status history for the customer is displayed, and unregistered users will not be logged-on.

Thus, by practice of embodiments of the invention associated with the logic flow diagram 1100 of FIG. 11, a sign-in procedure is conducted or performed for regular and EPP-user customers. A page is displayed having a title and a short description describing the sign-in process and having all required fields identified. The customer has the option to view his/her order status by either entering order number/phone number or username/password.

The associated scripts for embodiments of the invention illustrated in the logic flow diagram of FIG. 11 include profile/order_status_signin_view.jsp, profile/order_status_signin_control.jsp, profile/convert_username_view.jsp, and profile/convert_username_control.jsp.

The information captured in embodiments of the invention illustrated in FIG. 11 is listed in the following Table XXII:

TABLE XXII

| | | Information | | |
|---|---|---|---|---|
| Element | Format | Source | Stored In | Comments |
| User name | User input | Form text input | Html form | Used to sign in |
| Order | User input | Form text input | Html form | Used to retrieve |
| number | | | | order status for |
| | | | | order number |
| | | | | specified without |
| | | | | signing-in customer |
| Password | User input | Form password | Html form | Used to sign in |
| | | input | | |

The information provided in embodiments of the invention illustrated in FIG. 11 is listed in the following Table XXIII:

TABLE XXIII

| Element | Format | Information Source | Stored In | Comments |
|---|---|---|---|---|
| Salesrep | Session | Homepage | Session | Used to transfer |
| | | | | shopping cart to |
| | | | | registered customer |
| User type | Session | Checkout login page | Cookie | Used to distinguish |
| | | | | registered vs. |
| | | | | unregistered |
| Greeting | Session | BV_USER_PROFILE | Cookie | Used to display name at |
| | | | | the top navbar |
| User id | Session | BV_USER | Cookie | Used to automatically |
| | | | | sign in customer |
| Cart id | Session | Database sequence | Cookie | Used to display |
| | | | | persistent shopping cart |
| Diff user | Session | Homepage | Session | Used to decide whether |
| | | | | or not the persistent cart |
| | | | | should be transferred |
| Hpcart | Session | Homepage | Session | Persistent shopping cart |
| Directory | Session | HP_EPP_COMPANY | DIRECTORY | Used for EPP customer |
| Company name | Session | HP_EPP_COMPANY | NAME | Used for EPP customer |
| Company id | Session | HP_EPP_COMPANY | COMPANY_ID | Used for EPP customer |
| Company cic | Session | HP_EPP_COMPANY | Cic | Used for EPP customer |
| BI cookie | Session | Current page | Session variable | Used for Business |
| variable | | | | Intelligence reporting |

The navigation choices provided in embodiments of the invention illustrated in FIG. 11 is listed in the following Table XXIV:

TABLE XXIV

| Link Name | Format | Link To | Comments |
|---|---|---|---|
| Sign in | Form submit button | Same page | |
| Clear form | Href image link | Same page | |

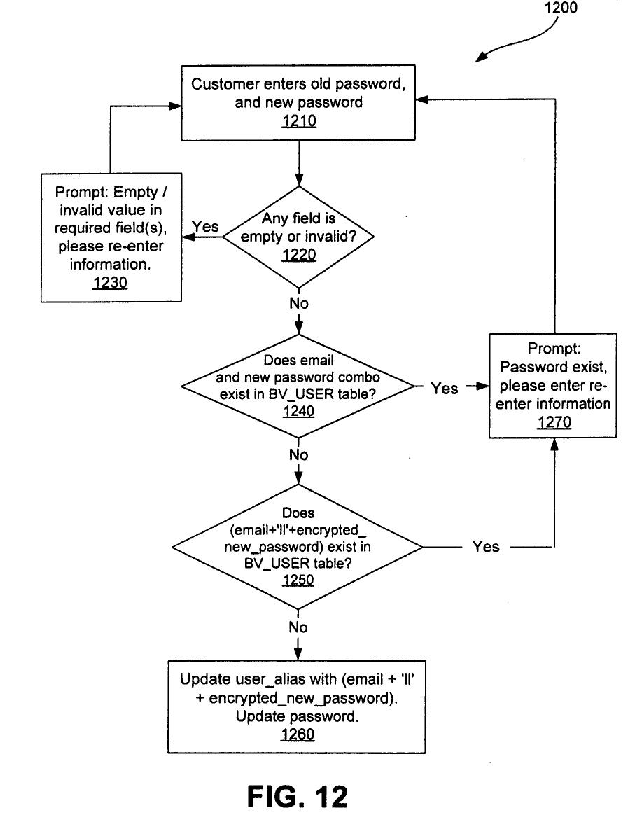

Referring now to FIG. 12 there is seen a schematic flow diagram, generally illustrated as 1200, of logic employed by a computer system for changing a password page. The following logic will be performed by practice of embodiments of the logic flow diagram 1200 of FIG. 12: (i) a script will ensure that all required fields have been properly filled out; if not, an error message will be displayed; (ii)if customer enters a password that, together with stored email, already exists in the BV_USER table, he/she will be prompted to enter a new password; (iii)if customer enters correct current password and new password that does not exist in the BV_USER table, update user_alias field with <email>||<encrypted_new_password> and password in the BV_USER table.

More specifically with respect to the logic flow diagram 1200, for the instructions in block 1210 to be appropriately performed a suitable page (e.g., a pass word page) with appropriate fields may be displayed, set forth or otherwise presented on one or more of the web pages 304 of the publishing system 303. After the suitable page has been displayed, a customer enters old password and new password in accordance with block 1210. From block 1210 the logic flow proceeds to decision block 1220 to determine if any field is empty or invalid. If the decision or determination in accordance with decision block 1220 is affirmative in that there is/are one or more empty and/or invalid fields, the logic flow proceeds to the instructions of block 1230 where the customer is prompted to reenter appropriate information in the empty and/or invalid fields. If the decision or determination in accordance with decision block 1220 is negative or “no” because there is/are no one or more empty and/or invalid fields, the logic flow proceeds to decision block 1240 for determining if the combination of the email address and the new password exist in the BV_USER table. If the combination does not exist in the BV_USER table, the logic flow proceeds to decision block 1250 to determine if the <email>||<encrypted_new_password> and password exists in the BV_USER table. If the determination of decision block 1240 or decision block 1250 is affirmative or “yes”, the customer is prompted to enter the re-enter information in accordance with block 1270, and the logic flow proceeds back to block 1210. If the determination of decision block 1250 is negative or “no”, then the logic flow proceeds to block 1260 for updating user_alias field with <email>||<encrypted_new_password> and for updating the password in the BV_USER table.

Thus, by practice of embodiments of the invention associated with the logic flow diagram 1200 of FIG. 12, a change password page procedure is conducted or performed for customers. A page is displayed having a title and a short description describing the change password page procedure and having all required fields identified. The customer is required to enter old password, new password, and confirm new password in order to change password. There is a links to “security” page.

The associated scripts for embodiments of the invention illustrated in the logic flow diagram of FIG. 12 include profile/change_password_view.jsp, and profile/change_password _control.jsp.

The information captured in embodiments of the invention illustrated in FIG. 12 is listed in the following Table XXV:

TABLE XXV

| Element | Format | Information Source | Stored In | Comments |
|---|---|---|---|---|
| Visitor | Session | Memory | Session object | For access visitor info DB |
| User alias | Database | BV_USER table | USER_ALIAS | |
| | | | field | |
| Password | Database | BV_USER table | PASSWORD | |
| | | | field | |
| Old password | User input | Form text input | Html form | Encrypted & not showing |
| | | | | input when error occurs |
| New password | User input | Form text input | Html form | Encrypted & not showing |
| | | | | input when error occurs |
| Verify new | User input | Form text input | Html form | Encrypted & not showing |
| password | | | | input when error occurs |

The information provided for embodiments of the invention illustrated in FIG. 12 is listed in the following Table XXVI:

TABLE XXVI

| Element | Format | Information Source | Stored In | Comments |
|---|---|---|---|---|
| Password | Database | BV_USER table | PASSWORD | |
| | | | field | |

The navigation choices provided in embodiments of the invention illustrated in FIG. 12 is listed in the following Table XXVII:

TABLE XXVII

| Link Name | Format | Link To | Comments |
|---|---|---|---|
| Clear form | Image link | Same page | Client-side JavaScript |
| Secure link | Image link | Pop-up window | |
| Update | Image link | Same page | |

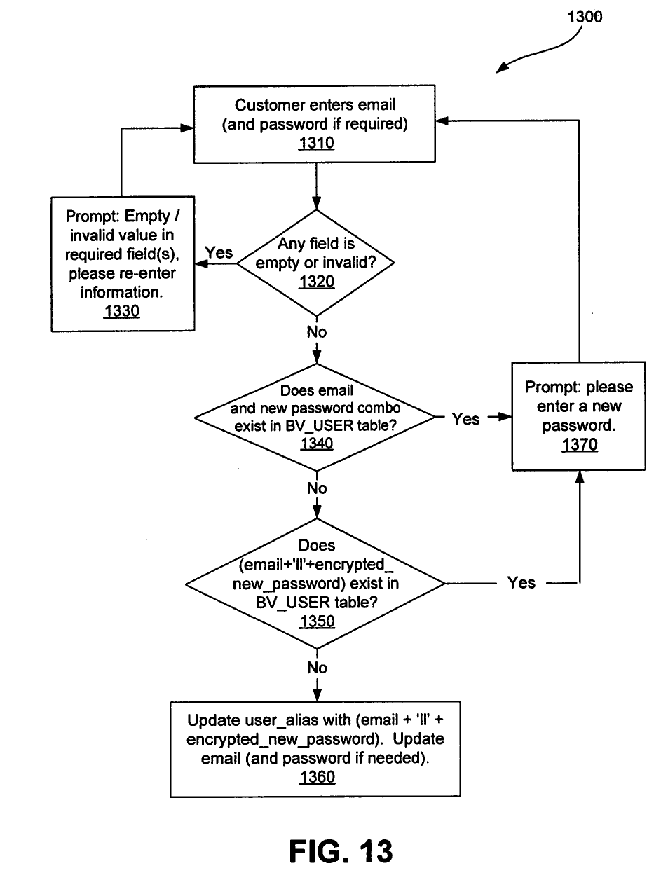

Referring now to FIG. 13 there is seen a schematic flow diagram, generally illustrated as 1300, of logic employed by a computer system for changing an email page. The following logic will be performed by practice of embodiments of the logic flow diagram 1300 of FIG. 13: (i) a script will ensure that all required fields have been properly filled out; if not, an error message will be displayed; and (ii)if customer enters an email address that, together with stored password, already exists in the BV_USER table, he/she will be prompted to enter a new password.

More specifically with respect to the logic flow diagram 1300, for the instructions in block 1310 to be appropriately performed a suitable page (e.g., an email page) with appropriate fields may be displayed, set forth or otherwise presented on one or more of the web pages 304 of the publishing system 303. After the suitable page has been displayed, a customer enters email (and password if required) in accordance with block 1310. From block 1310 the logic flow proceeds to decision block 1320 to determine if any field is empty or invalid. If the decision or determination in accordance with decision block 1320 is affirmative in that there is/are one or more empty and/or invalid fields, the logic flow proceeds to the instructions of block 1330 where the customer is prompted to reenter appropriate information in the empty and/or invalid fields. If the decision or determination in accordance with decision block 1320 is negative or “no” because there is/are no one or more empty and/or invalid fields, the logic flow proceeds to decision block 1340 for determining if the combination of the email address and the new password exist in the BV_USER table. If the combination does not exist in the BV_USER table, the logic flow proceeds to decision block 1350 to determine if the <email>||<encrypted-new-password> exists in the BV_USER table. If the determination of decision block 1340 or decision block 1350 is affirmative or “yes”, the customer is prompted to enter the re-enter information in accordance with block 1370, and the logic flow proceeds back to block 1310. If the determination of decision block 1350 is negative or “no”, then the logic flow proceeds to block 1360 for updating user_alias field with <email>||<encrypted_new_password> and for updating the email (and password if needed) in the BV_USER table.

Thus, by practice of embodiments of the invention associated with the logic flow diagram 1300 of FIG. 13, a change email page procedure is conducted or performed for customers. A page is displayed having a title and a short description describing the change email page procedure and having all required fields identified. The customer is required to enter email in order to change email. There is a links to “security” page.

The associated scripts for embodiments of the invention illustrated in the logic flow diagram of FIG. 13 include profile/change_email_view.jsp, and profile/change_email_control.jsp.

The information captured in embodiments of the invention illustrated in FIG. 13 is listed in the following Table XXVIII:

TABLE XXVIII

| | | Information | | |
|---|---|---|---|---|
| Element | Format | Source | Stored In | Comments |
| Visitor | Session | Memory | Session object | For access |
| | | | | visitor |
| | | | | info DB |
| User alias | Database | BV_USER table | USER_ALIAS | |
| | | | field | |
| Password | Database | BV_USER table | PASSWORD | |
| | | | field | |

The information provided in embodiments of the invention illustrated in FIG. 13 is listed in the following Table XXIX:

TABLE XXIX

| | | Information | | |
|---|---|---|---|---|
| Element | Format | Source | Stored In | Comments |
| User alias | Database | BV_USER table | USER_ALIAS | |
| | | | field | |
| Password | Database | BV_USER table | PASSWORD | Needed if |
| | | | field | email/pass- |
| | | | | word combi- |
| | | | | nation |
| | | | | exists |

The navigation choices provided in embodiments of the invention illustrated in FIG. 13 is listed in the following Table XXX:

TABLE XXX

| Link Name | Format | Link To | Comments |
|---|---|---|---|
| Clear form | Image link | Same page | Client-side JavaScript |
| Secure link | Image link | Pop-up window | |
| Update | Image link | Same page | |

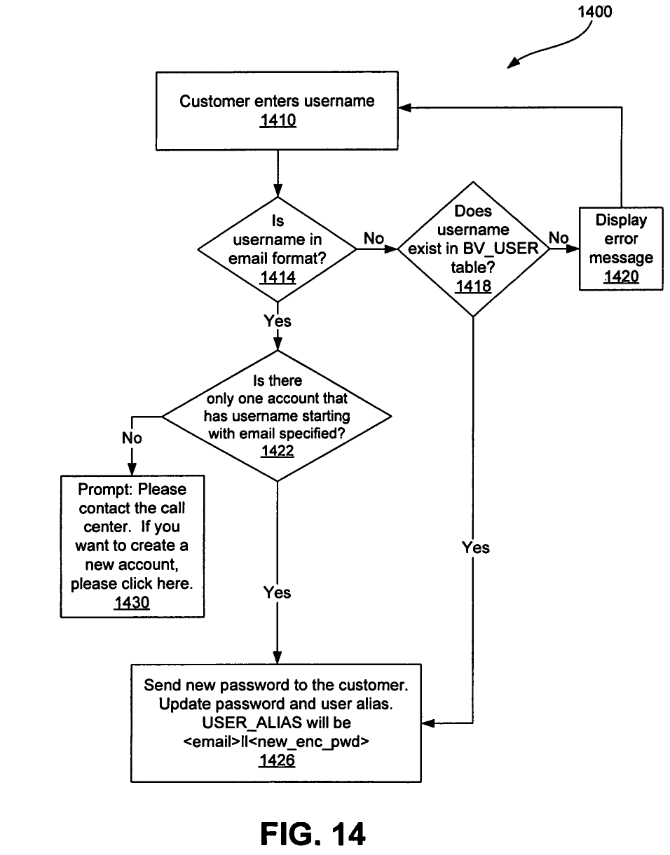

Referring now to FIG. 14 there is seen a schematic flow diagram, generally illustrated as 1400, of logic employed by a computer system for the event a customer forgets a password. The following logic will be performed by practice of embodiments of the logic flow diagram 1400 of FIG. 14: (i)if a customer enters an invalid username, an error message is displayed; (ii)if a customer enters a non-unique email address, the customer is prompted to create a new account; (iii)if customer enters a valid username or unique email, a new password is sent to customer's email address, the new password is updated and the user alias is updated with <email>||<encrypted-new-password>.

More specifically with respect to the logic flow diagram 1400, in block 1410 the customer enters username in a forgot-password page which may be set forth or otherwise presented on one or more of the web pages 304 of the publishing system 303. When the forgot-password page is suitably displayed, and after the username has been entered, the logic flow diagram 1400 proceeds to decision block 1414 to determine if the username is in email format. If username is not in email format, then the logic flow diagram 1400 proceeds to decision block 1418. If the username is in email format, then the logic flow diagram 1400 proceeds to decision block 1422.

By decision block 1418 a determination is made as to whether or not the username exist in the BV_USER table. if the determination is negative or no, then an error is displayed in accordance with block 1420 (i.e., “display error” block 1420) and the logic flow returns to block 1410. If the determination is affirmative or yes, then the logic flow proceeds to block 1426 for sending a new password to the customer, and for updating password and user alias. The USER_ALIAS becomes <email>||<encrypted_new_password>.

In or by decision block 1422, a determination is made as to whether or not there is only one account that has the username starting with the email specified. If the determination by decision block 1422 is positive or “yes”, then the logic flow proceeds to block 1426. If the determination is negative or “no”, then in accordance with block 1430 the customer is prompted to contact the call center for being inquired as to whether or not the customer desires to create a new account.

Thus, by practice of embodiments of the invention associated with the logic flow diagram 1400 of FIG. 14, a forgot password page procedure is conducted or performed for customers. A page is displayed having a title and a short description describing the forgot password page procedure and having all required fields identified. The customer is required to enter a username or enter address in order to obtain a new password.

The associated scripts for embodiments of the invention illustrated in the logic flow diagram 1400 of FIG. 14 include profile/forgot_password_view.jsp, and profile/forgot_password_control.jsp.

The information captured in embodiments of the invention illustrated in FIG. 14 is listed in the following Table XXXI:

TABLE XXXI

| Element | Format | Information Source | Stored In | Comments |
|---|---|---|---|---|
| Visitor | Session | BVI_Visitor object | Session object | |
| Username | User input | Text input or | Html form or | Generic login id, or email, |
| | or database | BV_USER table | USER_ALIAS | or <email>∥<password> |
| | | | field | |

The information provided in embodiments of the invention illustrated in FIG. 14 is listed in the following Table XXXII:

TABLE XXXII

| | | | | |
|---|---|---|---|---|
| Password | Database | BV_USER | PASSWORD | Password |
| | | | | is randomly |
| | | | | generated |

The navigation choices provided in embodiments of the invention illustrated in FIG. 14 is listed in the following Table XXXIII:

TABLE XXXIII

| Link Name | Format | Link To | Comments |
|---|---|---|---|
| Continue | Image link | Same page control | |

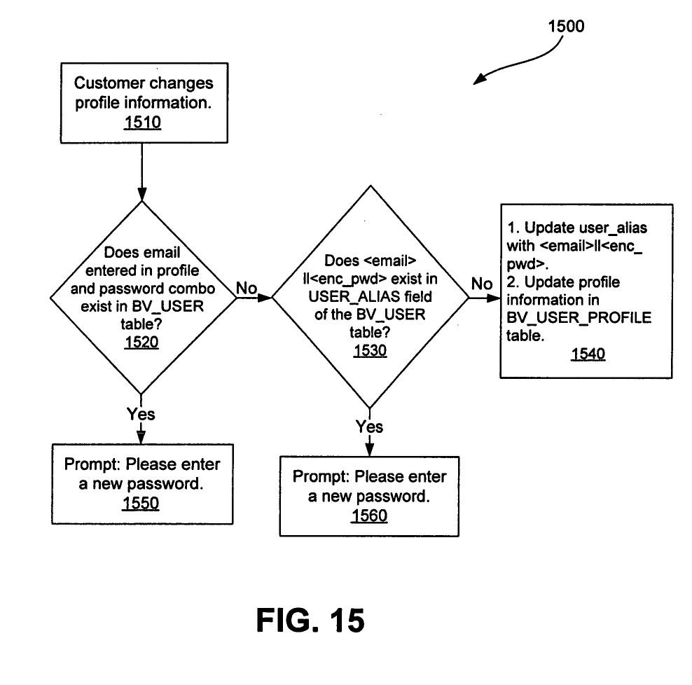

Referring now to FIG. 15 there is seen a schematic flow diagram, generally illustrated as 1500, of logic employed by a computer system for a customer to update a user profile field. The following logic will be performed by practice of embodiments of the logic flow diagram 1500 of FIG. 15: (i) a database check for a user; if user is registered, display user current profile data; (ii)script control ensures that all required fields are filled out and valid; if not, an error message is returned; and (iii)if all data in required fields is valid, the user profile may be updated.

More specifically with respect to the logic flow diagram 1500, for the instructions in block 1510 to be appropriately performed a suitable page with appropriate fields may be displayed, set forth or otherwise presented on one or more of the web pages 304 of the publishing system 303. After a suitable page has been displayed, a customer enters all required information (i.e., customer changes profile information) in accordance with block 1510. From block 1510 the logic flow proceeds to decision block 1520 to determine if the customer email and password combination exist in the BV_USER table. If the determination of decision block 1520 is negative or “no”, then the logic flow proceeds to decision block 1530 to determine if <email>||<encrypted password> exist in the USER_ALIAS field of the BV_USER table. If the determination of decision block 1530 is negative or “no”, then in accordance with block 1540 USER_ALIAS is updated with <email>||<encrypted password>, and all profile information is updated in BV_USER_PROFILE table.

If the determination of decision block 1520 or decision block 1530 is positive or “yes”, then the customer is prompted to enter a new password in accordance with block 1550 or block 1560, respectively.

Thus, by practice of embodiments of the invention associated with the logic flow diagram of FIG. 15, an updating-profile page procedure is performed for a customer. A page is provided having billing formation as part of user profile text fields, with pre-filled data if user has already signed in, including having the following: a check box for preference information, a popup link for more information about it, a popup link for secure information, and an image link to update.

The associated scripts for embodiments of the invention illustrated in the logic flow diagram of FIG. 15 include profile/profile_view.jsp, profile/profile_control.jsp, and utils/info_check_utils.jsp.

The information captured in embodiments of the invention illustrated in FIG. 15 is listed in the following Table XXXIV:

TABLE XXXIV

| Element | Format | Information Source | Stored In | Comments |
|---|---|---|---|---|
| Visitor | Session | BVI_Visitor object | Session object | |
| First name | User | Text input or table | Html form or FIRST_NAME | |
| | input or | BV_USER table | field | |
| | database | | | |
| Last name | User | Text input or table | Html form or LAST_NAME | |
| | input or | BV_USER table | field | |
| | database | | | |
| Email | User | Text input or table | Html form or EMAIL field | |
| address | input or | BV_USER table | | |
| | database | | | |
| Address | User | Text input or table | Html form or ADDRESS field | |
| | input or | BV_USER table | | |
| | database | | | |
| Address | User | Text input or table | Html form or ADDRESS_2 | |
| (contd.) | input or | BV_USER_PROFILE | field | |
| | database | | | |
| City | User | Text input or table | Html form or CITY field | |
| | input or | BV_USER_PROFILE | | |
| | database | | | |
| State | User | Text input or table | Html form or STATE field | |
| | input or | BV_USER_PROFILE | | |
| | database | | | |
| Zip code | User | Text input or table | Html form or ZIP field | |
| | input or | BV_USER_PROFILE | | |
| | database | | | |
| Phone | User | Text input or table | Html form or PHONE field | |
| | input or | BV_USER_PROFILE | | |
| | database | | | |
| Remember | User | Text input or table | Html form or | |
| credit card | input or | BV_USER_PROFILE | REMEMBER_CREDIT_CARD | |
| | database | | field | |

The information provided in embodiments of the invention illustrated in FIG. 15 is listed in the following Table XXXV:

TABLE XXXV

| Element | Format | Information Source | Stored In | Comments |
|---|---|---|---|---|
| First name | Database | BV_USER_PROFILE | FIRST NAME | |
| Last name | Database | BV_USER_PROFILE | LAST NAME | |
| Email | Database | BV_USER_PROFILE | EMAIL | |
| address | | | | |
| Address | Database | BV_USER_PROFILE | ADDRESS | |
| Address | Database | BV_USER_PROFILE | ADDRESS_2 | |
| (contd.) | | | | |
| City | Database | BV_USER_PROFILE | CITY | |
| State | Database | BV_USER_PROFILE | STATE | |
| Zip code | Database | BV_USER_PROFILE | ZIP | |
| Phone | Database | BV_USER_PROFILE | PHONE | |
| Remember | Database | BV_USER_PROFILE | REMEMBER_CREDIT_CARD | |
| credit card | | | | |

The navigation choices provided in embodiments of the invention illustrated in FIG. 15 is listed in the following Table XXXVI:

TABLE XXXVI

| Link Name | Format | Link To | Comments |
|---|---|---|---|
| More info. | Image link | Credit card popup page | |
| Secure | Image link | Secure info popup page | |
| Update | Image link | Same page control | |

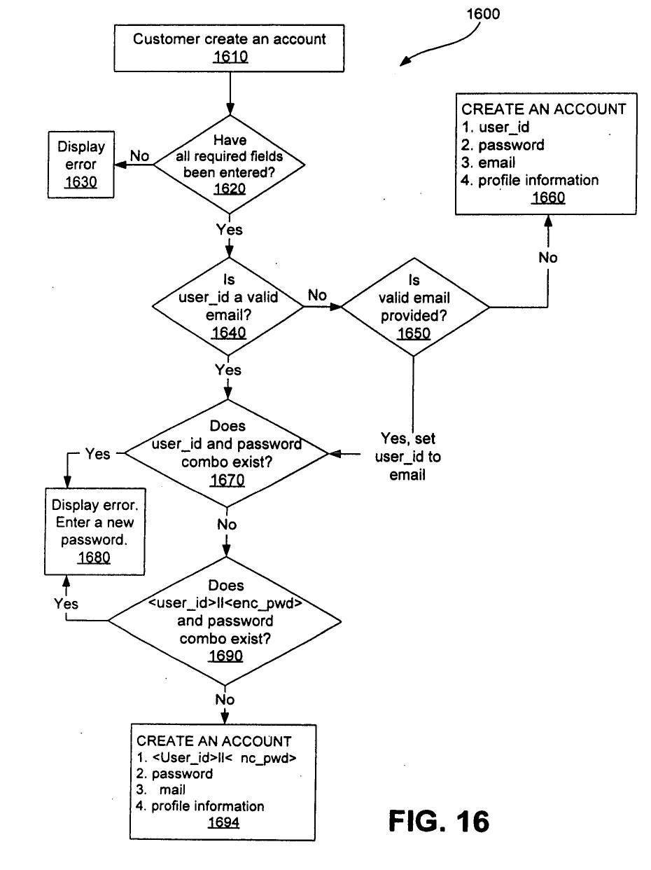

Referring now to FIG. 16 there is seen a schematic flow diagram, generally illustrated as 1600, of logic employed by a computer system for an agent to create an account for a customer. The following logic will be performed by practice of embodiments of the logic flow diagram 1600 of FIG. 16: (i) insuring that all required information has been entered; (ii)if user id is email-based, or if a valid email is entered, the account is created with the user_alias as <user_id/email>||<enc_password>; (iii) if the user_id/email and password combination does not exist, and also if the <user_id/email>||<enc_password> and password combination does not exist, the account is created with the user_alias as <user_id/email>||<enc_password>; and (iv) if the user_id/email and password combination does exist, and also if the <user_id/email>||<enc_password> and password combination does exist, the account is created with the user_alias as <user_id>.

More specifically with respect to the logic flow diagram 1600, for the instructions in block 1610 to be appropriately performed a suitable page with appropriate fields may be displayed, set forth or otherwise presented on one or more of the web pages 304 of the publishing system 303. After a suitable page has been displayed, a customer enters all required information (i.e., customer creates an account) in accordance with block 1610. From block 1610 the logic flow proceeds to decision block 1620 to determine if information has been entered in all required fields. If the determination by decision block 1620 is negative or “no”, then an error is displayed in accordance with the instructions in block 1630. If the determination by decision blocks 1620 is positive or “yes”. then the logic flow proceeds to decision block 1640 to determine if the user_id is a valid email address. If the user_id is not a valid email address, then a determination is made in accordance with decision block 1650 if a valid email address has been provided. If a valid email address was not validly provided, an account is created with the following: the user_id, the password, the email address, and the profile information (see instructions in block 1660).

If the determination by decision block 1640, or by decision block 1650, is affirmative or “yes”, then the logic flow proceeds to decision block 1670 for determining if the user_id and password combination exist. If the combination does exist, then an error message is displayed and a new password is to be entered, all per instructions in block 1680. If the combination does not exist, then the logic flow proceeds to decision block 1690 to determine the existence of the combination of the <user_id/email>||<enc_password> and password. If such combination does exist, then the logic flow proceeds to block 1680. If such combination does not exist, an account is created with the following: the <user_id/email>||<enc_password>, the password, the email address, and the profile information (see instructions in block 1694).

Thus, by practice of embodiments of the invention associated with the logic flow diagram 1600 of FIG. 16, an agent may create an account for a customer. A page is provided having fields for the customer to enter information for creating an account. More specifically, after all required information is identified, agent enters an email-based username if customer has an email address. If customer does not have an email address, no changes are made to present or today's functionality.

The associated scripts for embodiments of the invention illustrated in the logic flow diagram of FIG. 16 include customer/customercreate.jsp, agent/agentcall center.jsp, and include/login_utils.jsp.

The information captured in embodiments of the invention illustrated in FIG. 16 is listed in the following Table XXXVII:

TABLE XXXVII

| Element | Format | Information Source | Stored In | Comments |
|---|---|---|---|---|
| Visitor | Session | BVI_Visitor object | Session object | |
| First name | User | Text input or table | Html form or FIRST_NAME | |
| | input or | BV_USER_PROFILE | field | |
| | database | | | |
| Last name | User | Text input or table | Html form or LAST_NAME | |
| | input or | BV_USER_PROFILE | field | |
| | database | | | |
| Email | User | Text input or table | Html form or EMAIL field | |
| address | input or | BV_USER_PROFILE | | |
| | database | | | |
| Address | User | Text input or table | Html form or ADDRESS field | |
| | input or | BV_USER_PROFILE | | |
| | database | | | |
| Address | User | Text input or table | Html form or ADDRESS_2 | |
| (contd.) | input or | BV_USER_PROFILE | field | |
| | database | | | |
| City | User | Text input or table | Html form or CITY field | |
| | input or | BV_USER_PROFILE | | |
| | database | | | |
| State | User | Text input or table | Html form or STATE field | |
| | input or | BV_USER_PROFILE | | |
| | database | | | |
| Zip code | User | Text input or table | Html form or ZIP field | |
| | input or | BV_USER_PROFILE | | |
| | database | | | |
| Phone | User | Text input or table | Html form or PHONE field | |
| | input or | BV_USER_PROFILE | | |
| | database | | | |

The information provided in embodiments of the invention illustrated in FIG. 16 is listed in the following Table XXXVIII:

TABLE XXXVIII

| Element | Format | Information Source | Stored In | Comments |
|---|---|---|---|---|
| First name | Database | BV_USER_PROFILE | FIRST_NAME | |
| Last name | Database | BV_USER_PROFILE | LAST_NAME | |
| Email address | Database | BV_USER_PROFILE | EMAIL | |
| Address | Database | BV_USER_PROFILE | ADDRESS | |
| Address (contd.) | Database | BV_USER_PROFILE | ADDRESS_2 | |
| City | Database | BV_USER_PROFILE | CITY | |
| State | Database | BV_USER_PROFILE | STATE | |
| Zip code | Database | BV_USER_PROFILE | ZIP_CODE | |
| Phone | Database | BV_USER_PROFILE | PHONE | |

The navigation choices provided in embodiments of the invention illustrated in FIG. 16 is listed in the following Table XXXIX:

TABLE XXXIX

| Link Name | Format | Link To | Comments |
|---|---|---|---|
| Save | Submit button | Same page control | |
| Cancel | Submit button | Same page control | |

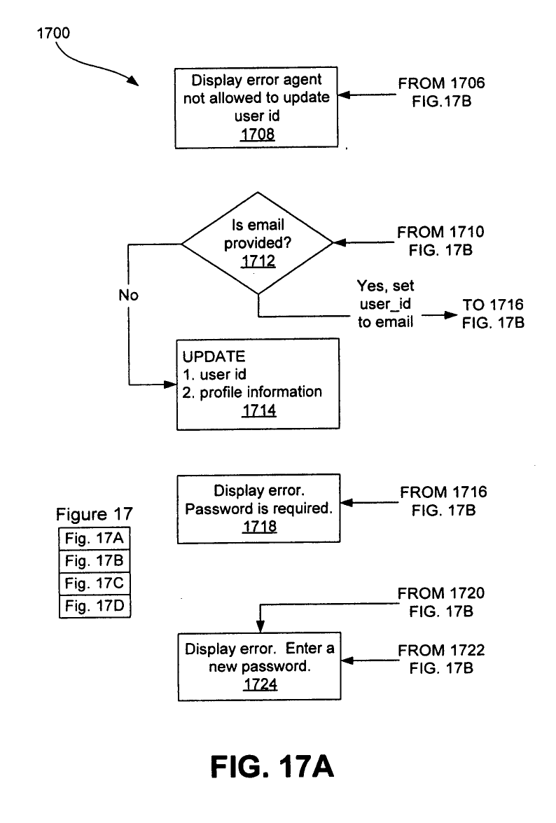

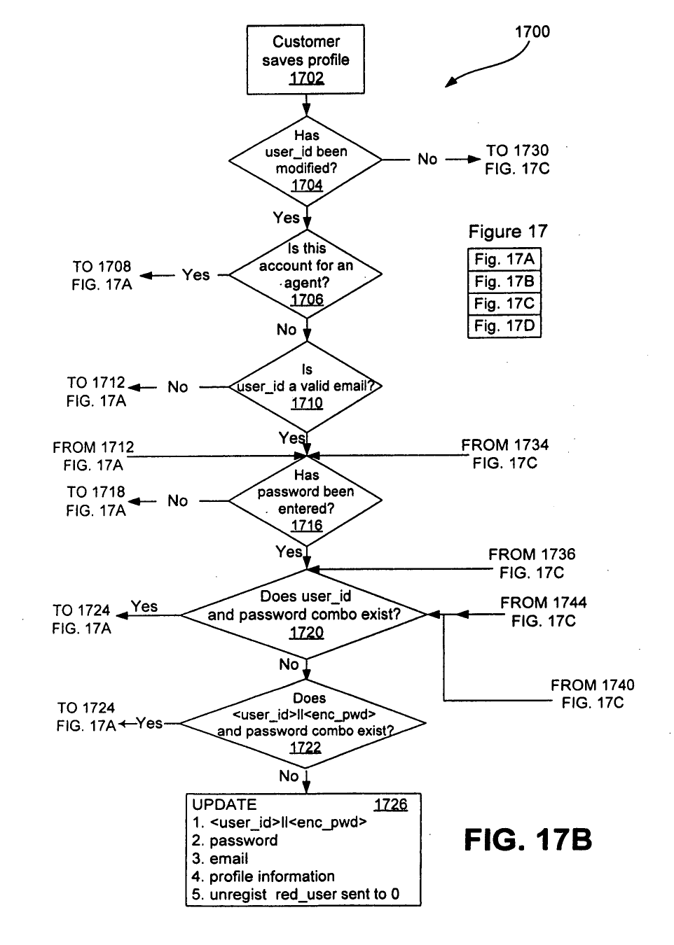

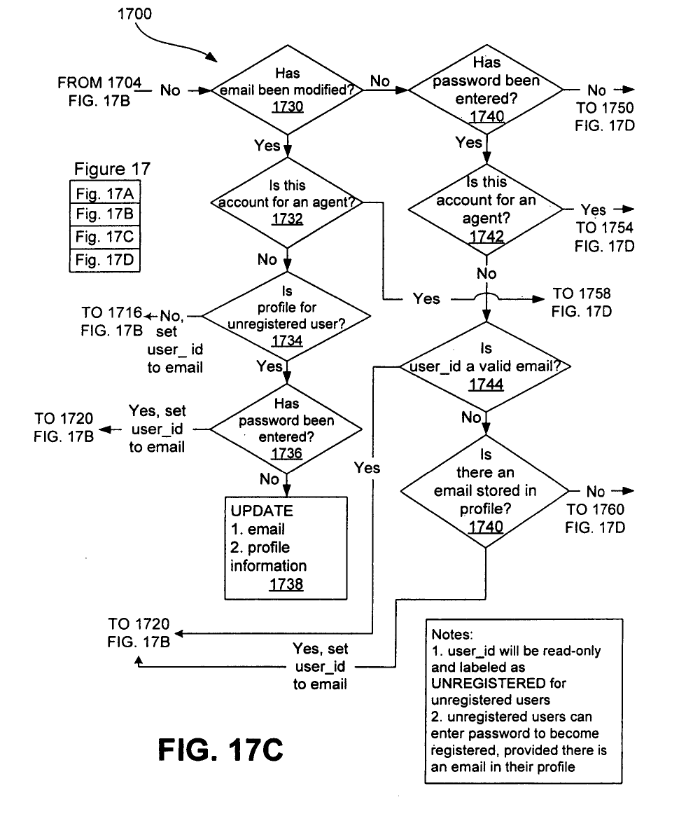

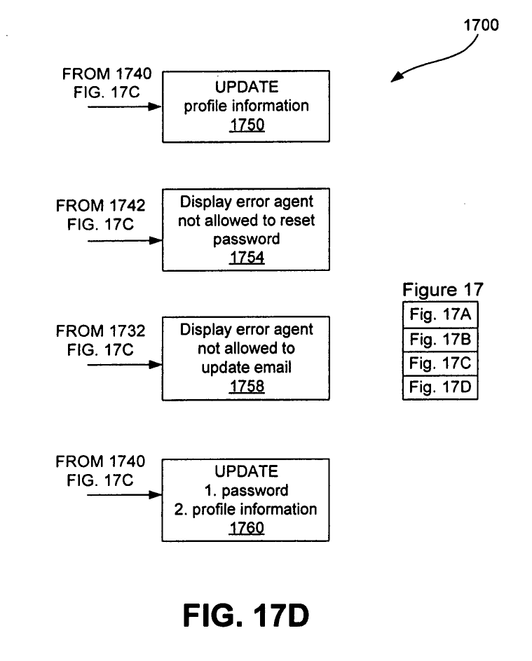

Referring now to FIG. 17 there is seen a schematic flow diagram, generally illustrated as 1700, of logic employed by a computer system for an agent to edit and/or update a profile for a customer. The following logic is performed by practice of embodiments of the logic flow diagram 1700 of FIG. 17:

(I) Case I where user_id has been modified: (i)if agent attempts to update user id, an error is displayed; (ii)if user id is not a valid email address and a valid email is not provided, user_id and profile information is updated; (iii)if user id is a valid email address or a valid email is provided, the password is entered, and the account is updated with the user_alias as <user_id/email>||<enc_password> (note: this conversion is generally successful if the user _id/email and password combination, and the <user-id/email>||<enc-password> and password combination, do not exist).

(II)Case II where Email address has been modified: (i)if agent attempts to update an email address, an error is displayed; (ii)if the profile is for a registered user, set user_id to email address (preferable after insuring that the password has been entered), and the account is updated with the user_alias as <user_id/email>||<enc_password> (note: this conversion is generally successful if the user _id/email and password combination, and the <user_id/email>||<enc_password> and password combination, do not exist); (iii)if the profile is for unregistered user and the password has been entered, set user_id to email address (preferable after insuring that the password has been entered), and the account is updated with the user_alias as <user_id/email>||<enc_password> (note: this conversion is generally successful if the user _id/email and password combination, and the <user_id/email>||<enc_password> and password combination, do not exist); and (iv)if profile is for an unregistered user and the password has not been entered, the email address and profile information are updated.

(III)Case III where the password has been entered: (i)if agent attempts to reset password, an error is displayed; (ii)if user id is a valid email address or a valid email address is provided, user_id is set to the email address, and the account is updated with the user_alias as <user_id/email>||<enc_password> (note: this conversion is generally successful if the user_id/email and password combination, and the <user_id/email>||<enc_password> and password combination, do not exist); and (iii) if the user id is not a valid email address and/or a valid email address is not provided, the password and profile information are updated. (IV)Case IV where profile information is updated.

More specifically with respect to the logic flow diagram 1700, for the instructions in block 1702 to be appropriately performed a suitable page with appropriate profile information may be displayed, set forth or otherwise presented on one or more of the web pages 304 of the publishing system 303. After a suitable page has been displayed, a customer saves a profile after entering all required information (i.e., customer creates a profile) in accordance with block 1702. From block 1702 the logic flow proceeds to decision block 1704 to determine if the user_id has been modified. If the determination by decision block 1704 is a “yes” or a positive determination, then the logic flow proceeds to decision block 1706 to determine whether or not the account is for an agent. If the account is for an agent, then an error message is displayed in accordance with block 1708 and the agent is not allowed to update the user_id. If the account is not for an agent, then a determination is made in accordance with decision block 1710 as to whether or not the user_id is a valid email address. If the account is not for an agent, then a determination is made as to whether or not the email address is provided (see instructions in block 1712). If the email address has not been provided, the user_id and profile information are updated in accordance with block 1714. If the determination in accordance with decision block 1712 is positive or “yes”, then the user_id is set to the email address and the logic flow proceeds to decision block 1716 for determining if the password has been entered.

If the determination by decision block 1710 is positive or “yes”, then the logic flow also proceeds to decision block 1716. If the password has not been entered, an error message is displayed and a password is now required (see instructions in block 1718). If a password has been entered, then a determination is made as to whether or not the combination of user_id and password exist (see query in decision block 1720). If the combination does not exist, the logic flow proceeds to decision block 1722 for determining whether or not the combination of the password and <user_id/emaii>||<enc_password> exist. If the determination in accordance with decision block 1720 or decision block 1722 is an affirmative or “yes” determination, then an error message is displayed per block 1724, and a new password is to be entered. If the determination in accordance with decision block 1722 is negative or a “no” decision, then the logic flow proceeds to block 1726 for updating the <user_id/email>||<enc_password>, the password, the email address, and the profile information, and for setting an unregistered_user to “0”.

If the determination in accordance with decision block 1704 is negative or “no” (i.e., the user_id has been modified), the logic flow proceeds to decision block 1730 for a determination as to whether or not the email address has been modified. If email address has been modified, then a determination is made in accordance with decision block 1732 if this account is for an agent. If the account is not for an agent, then a determination is made (per decision block 1734) as to whether or not the profile is for an unregistered user. If the profile is not for an unregistered user, the user_id is set to the email address and the logic flow proceeds to decision block 1716 for a determination as to whether or not the password has been entered. If the profile is indeed for an unregistered user (i.e., decision block 1734 produces an affirmative or “yes” response), then a determination is made as to whether or not the password has been entered (see decision block 1736). If the password has been entered, then the user_id is set to the email address and the logic flow proceeds to decision block 1720 for a determination as to whether or not the user_id and password combo exist. If the password has not been entered (i.e., decision block 1736 produces a negative or a “no” response), the logic flow proceeds to block 1738 for updating the email address and the profile information.

If the determination in accordance with decision block 1704 is negative or “no” (i.e., the user_id has been modified), the logic flow proceeds to decision block 1730 for a determination as to whether or not the email address has been modified. If email address has been modified, then a determination is made in accordance with decision block 1732 if this account is for an agent. If the account is for an agent, an error message is displayed and the agent is not allowed to update the email address (see instructions in block 1758). If the account is not for an agent, then a determination is made (per decision block 1734) as to whether or not the profile is for an unregistered user. If the profile is not for an unregistered user, the user_id is set to the email address and the logic flow proceeds to decision block 1716 for a determination as to whether or not the password has been entered. If the profile is indeed for an unregistered user (i.e., decision block 1734 produces an affirmative or “yes” response), then a determination is made as to whether or not the password has been entered (see decision block 1736). If the password has not been entered, then the profile information is updated in accordance with the instructions in block 1750. If the password has been entered, then the logic flow proceeds to decision block 1742 for a determination if this account is for an agent. If the account is for an agent, an error message is displayed and the agent is not allowed to update the email address (see instructions in block 1758). If the account is for an agent, then an error message is displayed per block 1754 and the agent is not allowed to reset the password. If the account is not for an agent, then the logic flow proceeds to decision block 1744 for a determination as to whether or not the user_id is a valid email address. If the determination per decision block 1744 is affirmative or “yes”, the logic flow proceeds to decision block 1720. If the determination in accordance with decision block 1744 is negative or “no”, then a determination is made as to whether or not there is an email address stored in the profile (see decision block 1746). If there is an email address stored in the profile (i.e., the determination by decision block 1746 is positive), then the user_id is set to the email address and the logic flow proceeds to decision block 1720. If there is no email address stored in the profile (i.e., the determination by decision block 1746 is negative), then the password and profile information are updated in accordance with the instructions of block 1760. With respect to the logic flow diagram 1700, it is to be noted that the user_id will typically be a read-only and labeled as “UNREGISTERED” for unregistered users. Unregistered user may enter a password to become a registered user, provided that there is an email address in his/her profile.

Thus, by the practice of embodiments of the invention associated with the logic flow diagram 1700 of FIG. 17, an agent may update a profile for a customer. A page is provided having fields for the agent to enter information for updating a profile for the customer. All required fields are verified. The customer search result page and edit profile page respectively contain UserID in user_id format An unregistered user is displayed “UNREGISTERED” in his/her UserID field and read-only, with proper message for him/her to convert to registered user if he/she enters password. The customer email field in the checkout page is displayed as read-only. The email address of any customer may be updated in the Edit Profile page.

The associated scripts for embodiments of the invention illustrated in the logic flow diagram 1700 of FIG. 17 include customer/customerEdit.jsp and include/login_utils.jsp.

The information captured in embodiments of the invention illustrated in FIG. 17 is listed in the following Table XXXX:

TABLE XXXX

| Element | Format | Information Source | Stored In | Comments |
|---|---|---|---|---|
| Visitor | Session | BVI_Visitor object | Session object | |
| First name | User | Text input or table | Html form or FIRST_NAME | |
| | input or | BV_USER_PROFILE | field | |
| | database | | | |
| Last name | User | Text input or table | Html form or LAST_NAME | |
| | input or | BV_USER_PROFILE | field | |
| | database | | | |
| Email | User | Text input or table | Html form or EMAIL field | |
| address | input or | BV_USER_PROFILE | | |
| | database | | | |
| Address | User | Text input or table | Html form or ADDRESS field | |
| | input or | BV_USER_PROFILE | | |
| | database | | | |
| Address | User | Text input or table | Html form or ADDRESS_2 | |
| (contd.) | input or | BV_USER_PROFILE | field | |
| | database | | | |
| City | User | Text input or table | Html form or CITY field | |
| | input or | BV_USER_PROFILE | | |
| | database | | | |
| State | User | Text input or table | Html form or STATE field | |
| | input or | BV_USER_PROFILE | | |
| | database | | | |
| Zip code | User | Text input or table | Html form or ZIP field | |
| | input or | BV_USER_PROFILE | | |
| | database | | | |
| Phone | User | Text input or table | Html form or PHONE field | |
| | input or | BV_USER_PROFILE | | |
| | database | | | |

The information provided in embodiments of the invention illustrated in FIG. 17 is listed in the following Table XXXXI:

TABLE XXXXI

| Element | Format | Information Source | Stored In | Comments |
|---|---|---|---|---|
| First name | Database | BV_USER_PROFILE | FIRST_NAME | |
| Last name | Database | BV_USER_PROFILE | LAST_NAME | |
| Email address | Database | BV_USER_PROFILE | EMAIL | |
| Address | Database | BV_USER_PROFILE | ADDRESS | |
| Address (contd.) | Database | BV_USER_PROFILE | ADDRESS_2 | |
| City | Database | BV_USER_PROFILE | CITY | |
| State | Database | BV_USER_PROFILE | STATE | |
| Zip code | Database | BV_USER_PROFILE | ZIP | |
| Phone | Database | BV_USER_PROFILE | PHONE | |

The navigation choices provided in embodiments of the invention illustrated in FIG. 17 is listed in the following Table XXXXII:

TABLE XXXXII

| Link Name | Format | Link To | Comments |
|---|---|---|---|
| Save | Submit button | Same page control | |
| Cancel | Submit button | Same page control | |

Reference throughout this specification to “one embodiment”, “an embodiment”, or “a specific embodiment” means that a particular feature, structure, or characteristic described in connection with the embodiment is included in at least one embodiment of the invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the invention may be combined in any suitable manner with one or more other embodiments. It is to be understood that other variations and modifications of the embodiments of the invention described and illustrated herein are possible in light of the teachings herein and are to be considered as part of the spirit and scope of the invention.

Further, at least some of the components of an embodiment of the invention may be implemented by using a programmed general purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention.

Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to. adapt a particular situation or material to the essential scope and spirit of the invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A method for placing an order in an electronic commerce environment, the method comprising:
Entering, in an electronic commerce environment customer, identification information comprising a combination of a first customer identifying characteristic and a second customer identifying characteristic;
determining that the customer identification information exist in data storage; and
placing an order for a product in the electronic commerce environment.

2. The method of claim 1 additionally comprising determining that the first customer identifying characteristic is in a desired format.

3. The method of claim 1 wherein said customer comprises a group with each member of the group having the same first customer identifying characteristic and a different second customer identifying characteristic.

4. The method of claim 1 wherein said first customer identifying characteristic comprises a username, and said second customer identifying characteristic comprises a password.

5. The method of claim 4 wherein said username comprises an email address, and said password comprises an account.

6. The method of claim 3 wherein said first customer identifying characteristic comprises a username, and said second customer identifying characteristic comprises a password.

7. The method of claim 6 wherein said username comprises an email address, and said password comprises an account.

8. The method of claim 3 wherein said customer comprises a group with each member of the group having the same username and a different password.

9. The method of claim 1 additionally comprising creating an account for the customer.

10. The method of claim 1 additionally comprising editing shipping and billing information.

11. The method of claim 10 additionally comprising displaying an information page prior to editing shipping and billing information.

12. The method of claim 11 wherein said information page is anchored to a first field of the shipping and billing information.

13. A method for a customer to enter an electronic commerce environment and to purchase a product comprising:
entering in an electronic commerce environment customer identification information comprising a combination of a first customer identifying characteristic and a second customer identifying characteristic;
determining that first customer identifying characteristic is in a desired format;
determining that the customer identification information exist in data storage to allow a customer to enter an electronic commerce environment; and
purchasing a product in the electronic environment.

14. The method of claim 13 wherein said desired format comprises an email format.

15. The method of claim 13 wherein said electronic commerce environment comprises a sign-in page having a user field.

16. The method of claim 15 additionally comprising updating the user field with the customer identification information.

17. The method of claim 13 wherein said first customer identifying characteristic comprises a username, and said second customer identifying characteristic comprises a password.

18. The method of claim 13 wherein said username comprises an email address, and said password comprises an account.

19. The method of claim 14 wherein said first customer identifying characteristic comprises a username, and said second customer identifying characteristic comprises a password.

20. The method of claim 19 wherein said username comprises an email address, and said password comprises an account.

21. The method of claim 17 wherein said customer comprises a group with each member of the group having the same username and a different password.

22. The method of claim 13 additionally comprising creating an account for the customer.

23. The method of claim 13 additionally comprising editing shipping and billing information.

24. The method of claim 23 additionally comprising displaying an information page prior to editing shipping and billing information.

25. The method of claim 24 wherein said information page is anchored to a first field of the shipping and billing information.

26. An apparatus for placing an order in an electronic commerce environment, the apparatus comprising:
means for entering, in an electronic commerce environment, customer identification information comprising a combination of a first customer identifying characteristic and a second customer identifying characteristic;
means for determining that the customer identification information exist in data storage; and
means for placing an order for a product in the electronic commerce environment.

27. An article of manufacture, comprising:
a machine-readable medium having stored thereon instructions to:
enter, in an electronic commerce environment, customer-identification information comprising a combination of a first customer identifying characteristic and a second customer identifying characteristic;
determine that the customer-identification information exist in data storage; and
place an order for a product in the electronic commerce environment.

28. An apparatus for placing an order in an electronic commerce environment, the apparatus comprising:
a computer system configured to enter, in an electronic commerce environment, customer identification information comprising a combination of a first customer identifying characteristic and a second customer identifying characteristic, to determine that the customer identification information exist in data storage, and to place an order for a product in the electronic commerce environment.

29. The apparatus of claim 28 wherein said customer comprises a group with each member of the group having the same first customer identifying characteristic and a different second customer identifying characteristic.

30. The apparatus of claim 28 wherein said first customer identifying characteristic comprises a username, and said second customer identifying characteristic comprises a password.

31. The apparatus of claim 30 wherein said username comprises an email address, and said password comprises an account.
